(19) United States
(12) Patent Application Publication
(10) Pub. No.: US 2026/0001049 A1
(43) Pub. Date: Jan. 1, 2026

(54) MIXING DEVICE

(71) Applicant: Mozarc Medical US LLC, Minneapolis, MN (US)

(72) Inventor: Niccolò Chelli, Rufina (IT)

(21) Appl. No.: 19/072,066

(22) Filed: Mar. 6, 2025

Related U.S. Application Data
(60) Provisional application No. 63/666,381, filed on Jul. 1, 2024.

(51) Int. Cl. B01F 25/46; B01F 23/40; B01F 23/45; B01F 23/50; B01F 25/60; B01F 101/22

(52) U.S. Cl. CPC B01F 25/46; B01F 23/405; B01F 23/452; B01F 23/49; B01F 23/51; B01F 23/59; B01F 25/60; B01F 2101/22

(57) ABSTRACT

In some examples, a mixing device is configured to receive a fluid flow in an inlet section and accelerate the fluid flow in a nozzle section fluidically coupled to the inlet section. The nozzle device is configured to discharge the fluid flow to an outlet section. The outlet section includes one or more suction ports configured to draw a material into the fluid flow via the suction ports. In some examples, the mixing device is configured to be secured to a container configured to hold a medical solution comprising the fluid flow and the material. In some examples, the mixing device is included in a mixing system configured to produce a medical solution.

This application claims the benefit of U.S. Provisional Patent Application Ser. No. 63/666,381, filed Jul. 1, 2024, which is entitled, “MIXING DEVICE” and is incorporated by reference herein in its entirety.

### TECHNICAL FIELD

The disclosure relates to generation of a medical solution

### BACKGROUND

Dialysis machines may be used to remove waste products from blood of a patient when the kidneys of the patient are no longer able to adequately do so. During dialysis, the dialysis machine may generate or regenerate dialysate using specified concentrations of solute buffers, osmotic agents, cations, and other concentrates for biocompatibility with the patient. The dialysis machine may provide the dialysate to a cycler for delivery to the patient. For example, the cycler may deliver the dialysate through a catheter into a peritoneal cavity of the patient. Toxins and metabolic waste products are exchanged from the blood of the patient to the dialysate. The dialysate including the toxins and waste products may be removed from the patient.

### SUMMARY

The present disclosure describes example devices, systems, and methods for the preparation of peritoneal dialysis fluid. In some examples, a system includes one or more containers holding one or more components of the peritoneal dialysis fluid (“PDF components”) in solid or concentrated liquid form. The one or more containers may be configured to receive a fluid (e.g., purified water) to cause dissolution and/or dilution of one or more PDF components, in order to produce a medical solution comprising the peritoneal dialysis fluid within the container. In examples, a mixing device may be configured to receive the fluid and draw in a PDF component within a container through a suction port to cause mixing of the fluid and the PDF component. The mixing device may be configured to draw in the PDF component by causing an acceleration of the fluid using a nozzle section and discharge a mixture of the fluid and the PDF component into a volume of the container. In examples, the mixing device is configured to receive the fluid (e.g., water) from a water source available in a patient's home, such that the patient or a caregiver may fluidly couple the mixing device to the water source to produce the medical solution. Hence, the mixing device may allow a patient or caregiver to cause the mixing of the medical solution, such that a container holding only the PDF component (e.g., a solid concentrate or a liquid concentrate) may be delivered to the patient or caregiver. This may reduce handling, storage, and delivery burdens on the patient or caregiver compared to systems which require delivery of fully mixed medical solutions and/or peritoneal dialysis solutions.

In examples, a first aspect of the disclosure relates to a system for mixing fluid. The system includes a mixing device including an inlet section, an outlet section, and a nozzle section connecting the inlet section and the outlet section. The inlet section defines a fluid inlet and is configured to receive a fluid flow through the fluid inlet. The nozzle section defines a nozzle inlet configured to receive the fluid flow from the inlet section, a nozzle outlet configured to discharge the fluid flow, and a nozzle passage fluidically coupling the nozzle inlet and the nozzle outlet. A width of the nozzle passage at the nozzle inlet and defined transverse to a direction of fluid flow is greater than a width of the nozzle passage at the nozzle outlet and defined transverse to the direction of the fluid flow through the fluid outlet, such that the nozzle section causes an acceleration of the fluid flow as the fluid flow proceeds through the nozzle section. The outlet section is configured to receive the fluid flow from the nozzle outlet and defines a fluid outlet configured to discharge the fluid flow. The outlet section may define a wall surface and an outlet passage extending from the wall surface to the fluid outlet, wherein the nozzle outlet opens to the wall surface, and wherein a width of the wall surface transverse to the direction of the fluid flow is greater than the width of the nozzle passage at the nozzle outlet. The outlet section defines a suction port which opens into the outlet passage, such that a suction produced by the fluid flow passing through the nozzle section into the outlet section draws a material through the suction port and into the fluid flow. In examples, the suction port opens into the outlet passage near the wall surface.

In examples, a length of an outlet passage defined by the outlet section (e.g., length L1 (FIG. 5)) is no greater than about four times a width of the fluid outlet (e.g., width W3 (FIG. 5)). In some examples, the width of the fluid outlet is no greater than about 2 millimeters (mm). In some examples, a width of the fluid inlet (e.g., width W1 (FIG. 5)) is no greater than about 5.5 mm. In some examples, the inlet section is connected to a source of fluid, such as a source of purified water. The fluid inlet may be fluidically coupled to source of fluid. In some examples, the inlet section, the nozzle section, and the outlet section are formed from a single injection-molded polymer component. In some examples, the width of the nozzle outlet is less than or equal to about 1.5 mm, and a width of the nozzle inlet and/or the fluid inlet is greater than or equal to about 6 mm.

In some examples, the outflow section further includes a solute section configured to dispense a solid concentrate through the suction port. In some examples, the fluid mixer includes a solute section configured to dispense a liquid concentrate through the suction port. The solid concentrate and/or liquid concentrate may mix with a fluid such as purified water to form a peritoneal dialysis fluid and/or a liquid intended to comprise a peritoneal dialysis fluid. In examples, the fluid flow passing through the mixing device can be purified water.

In examples, a second aspect of the disclosure relates to an on-demand system for generating a medical solution (e.g., a peritoneal dialysis solution), the system including at least a first container defining a first container volume and a second container defining a second container volume. In examples, at least one of the first container volume or the second container volume holds a concentrate. The concentrate may include ions, dextrose, and mixtures thereof, and may be in either liquid or powder form. In some examples, the system includes a third container defining a third container volume. The system is configured to fluidically couple the third container volume to the first container volume and/or the second container volume. The system may include at least one mixing device fluidically coupled to one of the first container volume, the second container volume, or the third container volume. In some examples, the system includes a first mixing device fluidically coupled to the first container volume, a second mixing device fluidically coupled to the second container volume, and/or a third mixing device fluidically coupled to the third container volume. In examples, the system includes at least one sensor configured to sense a concentration of at least one solute. For example, the sensor may be configured to sense the concentration within at least one of the first container volume, the second container volume, the third container volume, and/or a flow path (e.g., a conduit of the system) fluidically coupling the first container volume and/or the second container volume to the third container volume.

In any example, the system can have at least one pump configured to pump a fluid into at least one of the first container volume (e.g., via a first mixing device), the second container volume (e.g., via a second mixing device), and/or the third container volume (e.g., via a third mixing device). The fluid may be water (e.g., purified water). The system may include control circuitry configured to control the pump to pump the fluid into the first container volume, the second container volume, and/or the third container volume. In examples, the control circuitry is configured to cause the pump to pump the fluid based on at least one signal received from the at least one sensor.

In some examples, the first container volume holds a first concentrate and the second container volume holds a second concentrate. The first concentrate and/or the second concentrate may be solid concentrate or a liquid concentrate. The control circuitry may be configured to cause one or more pumps to pump fluid (e.g., water) into the first container volume to produce a first fluid comprising the first concentrate. The control circuitry may be configured to cause the one or more pumps to pump fluid (e.g., water) into the second container volume to produce a second fluid comprising the second concentrate.

The control circuitry may be configured to cause the one or more pumps to pump a first volume of the first fluid from the first container volume and a second volume of the second fluid from the second container volume into the third container volume. In examples, the control circuitry may be configured to cause the one or more pumps to pump additional fluid (e.g., additional water) into the third container volume (e.g., subsequent to and/or prior to pumping a first reconstituted and/or diluted concentrate and/or a second reconstituted and/or diluted concentrate into the third container volume). The control circuitry may be configured to cause the one or more pumps to pump the additional fluid based on the at least one signal from the sensor. In examples, the system is configured to mix the first fluid, the second fluid, and/or the additional fluid (e.g., using the third mixing device) to produce a peritoneal dialysate solution in the third container volume.

In examples, a mixing device comprises an inlet section configured to receive a fluid flow; a nozzle section defining: a nozzle inlet configured to receive the fluid flow from the inlet section, a nozzle outlet configured to discharge the fluid flow, and a nozzle passage fluidically coupling the nozzle inlet and the nozzle outlet, wherein a width of the nozzle passage at the nozzle inlet and transverse to a direction of the fluid flow is greater than a width of the nozzle passage at the nozzle outlet and transverse to the direction of the fluid flow; and an outlet section configured to receive the fluid flow from the nozzle outlet and defining a device outlet configured to discharge the fluid flow, wherein the outlet section defines a wall surface and an outlet passage extending from the wall surface to the device outlet, wherein the nozzle outlet opens to the wall surface, and wherein a width of the wall surface transverse to the direction of the fluid flow is greater than the width of the nozzle passage at the nozzle outlet, and wherein the outlet section defines a suction port which opens into the outlet passage near the wall surface such that a suction produced by the fluid flow passing through the nozzle section into the outlet section draws a material through the suction port and into the fluid flow.

In examples, a mixing device comprises an inlet section configured to receive a fluid flow; an outlet section configured to discharge the fluid flow; a nozzle section directly connecting the inlet section to the outlet section, wherein the nozzle section defines a nozzle inlet configured to receive a fluid flow from the inlet section and defines a nozzle outlet configured to discharge the fluid flow to the outlet section, the nozzle section tapering in a direction of the fluid flow through the mixing device such that the nozzle outlet is narrower than the nozzle inlet; and a suction port defined by the outlet section near the nozzle outlet, the suction port being configured such that a suction produced when the fluid flow passes through the nozzle section draws a material through the suction port to cause the material to mix with fluid flow.

In examples, a system for generating a peritoneal dialysis fluid comprises a first container defining a first volume configured to hold a first fluid; a second container defining a second volume configured to hold a second fluid, wherein at least one of the first volume or the second volume holds a concentrate, the concentrate including ions, dextrose, or mixtures thereof, and wherein the concentrate is one of a liquid or a powder; a third container defining a third volume, wherein the system defines a first flow path for the first fluid from the first volume to the third volume and defines a second flow path for the second fluid from the second volume to the third volume, wherein at least one of the first container, the second container, or the third container includes a mixing device, the mixing device defining: a device inlet configured to receive a fluid flow, a device outlet configured to discharge the fluid flow, and a suction port between the device inlet and the device outlet, wherein the suction port is configured such that a suction produced when the fluid flow passes from the device inlet to the device outlet draws a material from the one of the first container, the second container, or the third container through the suction port to cause the material to mix with fluid flow; and at least one sensor configured to sense a concentration of the concentrate in at least one of the first fluid, the second fluid, or a fluid in the third volume.

In examples, a method comprises accelerating, using a nozzle section of a mixing device, a fluid flow received by an inlet section of the mixing device; producing, using the fluid flow, a suction in an outlet section of the mixing device receiving the fluid flow from a nozzle outlet of the nozzle section, wherein the a nozzle outlet opens to a wall surface defined by the outlet section; drawing, through a suction port defined by the outlet section, a material into the fluid flow using a suction produced by the acceleration of the fluid flow, wherein the material comprises a medical solution; and discharging, through a device outlet defined by the outlet section, the fluid flow and the material.

The features disclosed as being part of the first aspect of the disclosure can be in the first aspect or the second aspect of the disclosure, either alone or in combination, or follow any arrangement or permutation of any one or more of the described elements. Similarly, any features disclosed as being part of the second aspect of the disclosure can be in the first aspect or the second aspect, either alone or in combination, or follow any arrangement or permutation of any one or more of the described elements.

### BRIEF DESCRIPTION OF THE DRAWINGS

FIG. 1 is a schematic illustration of an example system configured to generate a medical solution.

FIG. 2 is a schematic illustration of an example system configured to generate a medical solution.

FIG. 3 is a schematic illustration of an example container including a recirculation line.

FIG. 4 is a schematic plan view of an example container including a mixing device.

FIG. 5 is a cross-sectional view of an example mixing device.

FIG. 6 is a cross-sectional view of another example mixing device.

FIG. 7 illustrates a flow diagram of an example technique for producing a medical solution using a mixing device.

### DETAILED DESCRIPTION

The disclosure describes devices and systems configured to provide one or more medical solutions for use in a medical procedure, and related methods. In some examples, the medical solution is a peritoneal dialysis fluid or a fluid component of a peritoneal dialysis fluid. While the disclosure primarily refers to a peritoneal dialysis fluid, the devices, systems, and methods described herein can be used to generate other medical solutions.

The system is configured to mix two or more fluids and/or concentrates (e.g., solid or liquid concentrates) to produce the medical solution. For example, in some examples, the system is configured to mix a fluid (e.g., water) and a solid concentrate to produce the medical solution or a component (e.g., referred to herein as a first fluid or a second fluid) of the medical solution. The system may be configured to mix a first fluid (e.g., a first concentrated liquid) and a second fluid (e.g., a second concentrated liquid) to produce the medical solution. In some examples, the system is configured to mix a fluid (e.g., water) with a mixture of the first concentrated liquid and the second concentrated liquid to produce the medical solution.

The mixing system includes at least one mixing device configured to mix the two or more fluids and/or concentrates. The mixing device includes an inlet section configured to receive a fluid flow such as water (e.g., purified water) and deliver the fluid flow to a nozzle section. In examples, the inlet section defines a device inlet configured to receive the fluid flow. The nozzle section is configured to increase a fluid velocity of the fluid flow and provide the fluid flow to an outlet section. The mixing device is configured such that the increase in velocity causes a reduction in a pressure (e.g., a static pressure) of the fluid flow in the outlet section. The outlet section includes a suction port configured to draw a material into the fluid flow using the suction, such that the fluid flow and the material at least partially mix within the outlet section. The outlet section defines a device outlet is configured to discharge the fluid flow and the material drawn in through the suction port.

In examples, the system includes one or more containers, with at least one container defining a volume (“container volume”) configured to hold the material. The container may be secured to the mixing device. In examples, the container is secured to the mixing device such that the suction port draws the material from within the container volume as the fluid flow flows through the nozzle. The container volume may be configured such that further mixing of the fluid flow and the material occur within the container volume as the outlet section of the mixing device discharges the fluid flow and the material into the container volume. Hence, the system may be configured such that an introduction of the fluid flow (e.g., water and/or a liquid concentrate) causes a medical solution to be generated within the container volume. This may allow substantially in-situ production of the medical solution in a manner minimizing and/or avoiding a need for the storage and movement of relatively large and heavier containers of the medical solution. In examples, the medical solution is a dialysis fluid (e.g., a peritoneal dialysis fluid) for use in a dialysis procedure. In some examples, the medical solution comprises (e.g., is a component of) a dialysis fluid.

For example, the mixing devices and systems described herein may allow a patient or caregiver to receive supplies for an at-home dialysis process in the form of solid and/or liquid concentrates within a container, rather than a heavier container containing fully formulated peritoneal dialysis fluid (or other medical solution). The system may allow the patient or caregiver to produce the dialysate by providing the fluid flow (e.g., purified water) to the container from a local source, avoiding a necessity to store and/or manipulate heavier containers that already include the fluid prior to use. Hence, the system may ease the delivery and/or storage of medical solutions (e.g., dialysate) used in a medical procedure (e.g., a dialysis treatment).

As an example, peritoneal dialysis treatment may generally require 3-4 exchanges of peritoneal dialysis fluid per day totaling 12-15 L, and can be much more in some patients. Known systems and methods which use pre-mixed, sterilized peritoneal dialysis fluid and require storage of these solutions put significant burden on the patient using the fluids. Each patient may typically use a combination of three different peritoneal dialysis fluid formulations, and generally requires all three on-hand in case they are needed. Because supplies are typically delivered monthly, traditional peritoneal dialysis systems may require storage for upwards of 900-1,000 L of sterile fluid. Further, the patient or caregiver must move and manipulate large and cumbersome dialysate containers multiple times each day. In addition, because the pre-mixed fluids can freeze in cold weather, special accommodations may be required to receive and store the pre-mixed fluids to protect them from freezing in cold climates. This places additional burden on patients that live in cold climates.

The system disclosed is configured to prepare of medical solution (e.g., peritoneal dialysis fluid) with reduced storage and handling requirements. The system may include one or more containers holding a material (e.g., a solid concentrate and/or liquid concentrate) which comprise the medical solution. In examples, a mixing device is secured to at least one of the containers. The mixing device is configured to draw the material into a fluid flow when the fluid flow is provided to the mixing device. In some examples, such as when the medical solution comprises a first constituent (e.g., a first liquid concentrate) and a second constituent (e.g., a second liquid concentrate), the medical system may include a first container and first mixing device for preparation of the first constituent and a second container and second mixing device for preparation of the second constituent. The system may be configured to produce the first constituent in the first container when fluid is provided to the first mixing device and produce the second constituent in the second container when fluid is provided to the second mixing device. This may provide advantage when it is desirable to subject, for example, the first constituent to one or more preparation steps which might be undesired for the second constituent.

For example, the first container may include a first solid concentrate configured to mix with fluid provided via the first mixing device to produce the first constituent, such as a first liquid concentrate containing dextrose and/or lactate. The second container may include a second solid concentrate configured to mix with fluid provided via the second mixing device to produce the second constituent, such as a second liquid concentrate containing calcium, sodium, magnesium, and/or chloride (e.g., as ions). The system may be configured to subject the first constituent to a first process (e.g., a first amount of dilution and/or reconstitution) which might be undesired for the second constituent, and/or subject the second constituent to a second process (e.g., a second amount of dilution and/or reconstitution) which might be undesired for the first constituent. Hence, the system may be configured to maintain to separation between the first constituent and the second constituent until the first process and/or the second process has been performed.

The system may be configured to mix the first constituent and the second constituent (e.g., as liquids) in a third container subsequent to performing the first process and/or the second process to produce the medical solution (e.g., a dialysate). For example, the system may be configured to provide the first constituent from the first container to the third container. The system may be configured to provide the second constituent from the second container to the third container. In examples, the system includes one or more pumps and/or valves configured to define a flow path for the first constituent from the first container to the third container and/or define a flow path for the second constituent from the second container to the third container. The system may include control circuitry configured to control the one or more pumps and/or valves to cause the mixing of the first constituent and the second constituent in the third container. In examples, the system is configured to provide additional fluid (e.g., purified water) to the third container, such that the resulting medical solution within the third container is a mixture of the first constituent (e.g., the first liquid concentrate), the second constituent (e.g., the second liquid concentrate), and the additional fluid.

The system may include any number of containers and any number of mixing devices. In some examples, a mixing device is secured to a container, such that an outlet section of the mixing device discharges a fluid and/or material directly into a container volume defined by the container. In some examples, a mixing device is physically separated from and displaced from a container, such that the outlet section discharges a fluid and/or material into an intervening flow path (e.g., a flow path defined by a conduit of the system) and the intervening flow path directs the fluid and/or material into the container volume. In some examples, the system may include one or more first containers configured to receive a fluid and/or material from one or more second containers without an intervening mixing device present in the flow path between the first container and the second container.

In examples, the mixing device is configured to draw in the material (e.g., a solid concentrate and/or liquid concentrate) through a suction port defined by the mixing device to cause mixing of the material and the fluid flow. The mixing device is configured to create a suction acting through the suction port by causing an acceleration of the fluid as the fluid passes through a nozzle section. In examples, the mixing device is configured to provide a greatly expanded flow area available to accelerated fluid as the accelerated fluid exits the nozzle section. The relatively quick expansion of the flow area as the fluid exits the nozzle section acts to enhance the suction acting through the suction port, enhancing the mixing of the fluid and the material. The mixing device may be configured to receive the fluid (e.g., water) from a water source available in a patient's home, such that the patient or a caregiver may fluidly couple the mixing device to the water source and make use of the enhanced mixing to produce a medical solution (e.g., a peritoneal dialysis fluid or a medical solution intended to comprise a peritoneal dialysis fluid). Hence, the mixing device may allow a patient or caregiver to cause the mixing of the medical solution, such that a container holding only the material (e.g., the solid concentrate or the liquid concentrate) may be delivered to the patient or caregiver. This may reduce handling, storage, and delivery burdens on the patient or caregiver compared to systems which require delivery of fully mixed medical solutions and/or peritoneal dialysis solutions.

In some examples, a mixing device includes an inlet section defining a device inlet configured to receive a fluid flow and an outlet section defining a device outlet configured to discharge the fluid flow. The mixing device is configured to cause the fluid flow to flow through a nozzle section interposed between (e.g., separating) the inlet section and the outlet section. The nozzle section is configured to accelerate (e.g., increase a velocity of) the fluid flow to cause a reduction in the pressure (e.g., a static pressure) of the fluid flow. In examples, the nozzle section is configured such that a width of a nozzle passage at the nozzle inlet and transverse to a direction of the fluid flow is greater than a width of the nozzle passage at the nozzle outlet and transverse to the direction of the fluid flow. For example, a nozzle wall of the nozzle section may be configured to cause the nozzle passage to converge as the nozzle passage extends from the nozzle inlet toward the nozzle outlet. The converging nozzle passage may cause a fluid flow to accelerate as the fluid flow proceeds from the nozzle inlet to the nozzle outlet.

The outlet section is configured to receive the fluid flow from the nozzle outlet. The outlet section defines an outlet passage extending from the nozzle outlet to the device outlet and one or more suction ports opening into the outlet passage. In examples, the outlet section includes a boundary wall which defines a boundary of the outlet passage. For example, the boundary wall may surround a longitudinal axis defined by the mixing device and extending through the nozzle outlet and the device outlet. The one or more suction ports may each be a respective opening through the boundary wall which open into the outlet passage. The outlet section is configured to draw a material into the fluid flow via a suction port using the pressure reduction of the fluid flow that occurs as the nozzle section accelerates the fluid flow. In examples, the outlet section is configured to draw the material into the fluid flow via the suction port by causing an entrainment of the material and the fluid flow as the fluid flow passes through the outlet passage. In examples, the boundary wall is a substantially tubular wall.

The outlet section may be configured such that nozzle outlet discharges the fluid flow into a flow area which is larger than a flow area of the nozzle outlet. In examples, the outlet section is configured such that the boundary wall (e.g., a tubular wall) causes the flow area available to the fluid flow to abruptly increase as the fluid flow exits the nozzle outlet and enters the outlet section. The relatively abrupt increase in the flow area may enhance the suction caused by the fluid flow moving through the mixing device, enhancing the influx of material into the fluid flow via the suction port.

For example, the outlet section may define a wall surface configured to be substantially traverse (e.g., transverse or nearly transverse, such as within 15 degrees, e.g., within 5 degrees or within 10 degrees) to a direction of the fluid flow as the fluid flow proceeds from the nozzle inlet to the device outlet. In examples, the wall surface faces the device outlet. In some examples, the wall surface is substantially perpendicular (e.g., perpendicular or nearly perpendicular to the extent permitted by manufacturing tolerances) to the longitudinal axis. The nozzle outlet may open to the wall surface, such that a boundary of the nozzle outlet is defined by the wall surface. The wall surface may extend (e.g., substantially perpendicular to the longitudinal axis) from the boundary of the nozzle outlet toward the boundary wall to cause the relatively abrupt increase in the flow area as the fluid flow exits the nozzle outlet and enter the outlet section. The outlet section may define the suction port in relative proximity to (e.g., just downstream of) the wall surface to enhance suction of a material through the suction port and into the fluid flow.

The systems including such mixing devices are configured for the preparation of a dialysis fluid, such as preparation of peritoneal dialysis fluid, with minimal complexity and storage requirements. The system may include a container holding a material (e.g., a solid concentrate and/or liquid concentrate). The container may be configured to receive a fluid flow (e.g., via a mixing device) to produce a medical solution within a container volume of the container. The system may allow the patient or caregiver to produce the dialysate by providing the fluid flow (e.g., purified water) to the container from a local source, avoiding a necessity to store and/or manipulate heavier containers that already include the fluid prior to use. Hence, the system may ease the delivery and/or storage of medical solutions (e.g., dialysate) used in a medical procedure (e.g., a dialysis treatment).

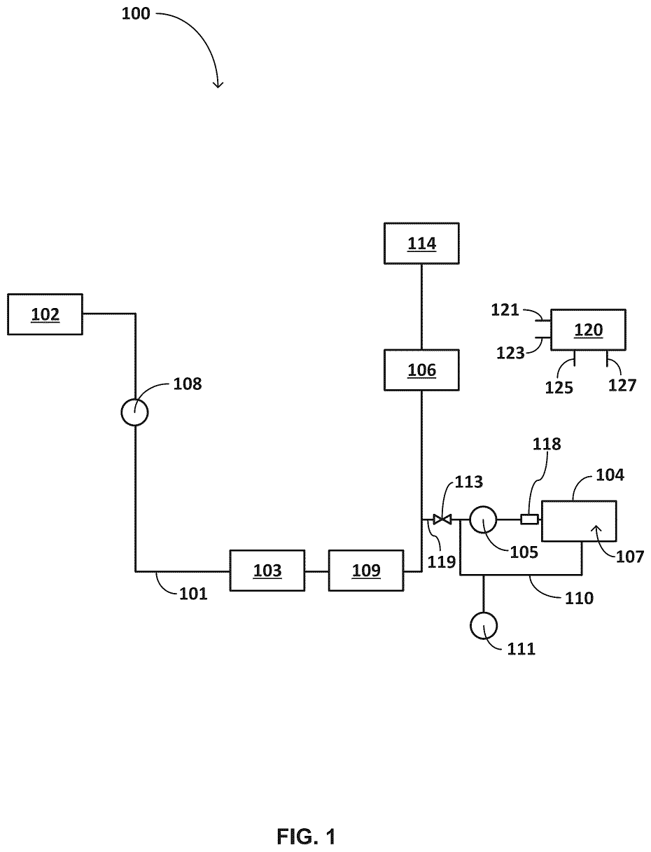

FIG. 1 schematically illustrates an example system 100 configured to generate a medical solution (e.g., a peritoneal dialysis fluid and/or a medical solution comprising a peritoneal dialysis fluid). System 100 includes one or more containers, such as a container 104. Container 104 defines a container volume 107 configured to hold a fluid. In examples, system 100 is configured to provide the fluid (e.g., water) to container 104 from a fluid source 102. In examples, system 100 includes a fluid line 101 configured to provide the fluid from fluid source 102 to container 104 (e.g., container volume 107). System 100 may include one or more pumps such as a pump 108 configured to pump the fluid. Pump 108 is configured to cause the fluid to flow (e.g., via fluid line 101) from fluid source 102 to container 104 and/or other portions of system 100.

In examples, system 100 includes one or more purification modules 103 (e.g., water purification modules) configured to purify and/or treat the fluid provided to container 104. System 100 may be configured to transport fluid from a fluid source 102 (e.g., via fluid line 101) and purification module 103 using pump 108. In examples, fluid source 102 is configured to provide potable or non-potable water. For example, fluid source 102 may be a tap water source, such as a home tap or faucet. In examples, fluid source 102 is configured to provide water meeting World Health Organization (WHO), United States Environmental Protection Agency (EPA), and/or European Union (EU) standards for drinking water. Purification module 103 may be configured to remove chemical contaminants from the fluid to, for example, convert the water from fluid source 102 into water meeting applicable pharmacopoeia requirements for peritoneal dialysis fluid.

Purification module 103 has any suitable configuration. In some examples, purification module 103 is configured to remove and/or replace ionic species from the fluid. In some examples, purification module 103 includes one or more of a sorbent, an exchange resin (e.g., an anion exchange resin and/or a cation exchange resin), and/or other materials configured to remove and/or replace ionic species in a fluid. In some examples, purification module 103 includes one or more activated carbon layers or blocks. In some examples, purification module 103 includes a softener configured to soften the fluid (e.g., to remove one or more minerals from the fluid).

The anion exchange material may be configured to remove anionic species from the fluid, such as nitrate, phosphate, and/or fluoride molecules. In examples, the anion exchange material is configured to replace the anionic species with acetate or hydroxide ions. The anion exchange material may be any material capable of removing anionic species from the fluid. In some examples, the sorbent includes a cation exchange material configured to remove cationic species from the fluid, such as potassium, calcium, magnesium, iron, or other cations. The cation exchange material may be configured to replace the cationic species with hydrogen and/or sodium. The cation exchange material may be any material capable of removing cations from the fluid.

Purification module 103 may include both an anion exchange material and a cation exchange material. In examples, purification module 103 includes at least one ion exchange layer which contains a mixed bed having both a cation exchange material and an anion exchange material. The mixed bed may be configured to generate hydrogen ions and hydroxyl ions as byproducts that form water (e.g., as the mixed bed removes and/or replaces anionic species and/or cationic species from the fluid).

In examples, purification module 103 includes a carbon material (e.g., an activated carbon material). The carbon material may be configured to adsorb or absorb non-ionic molecules, organic molecules, chlorine, chloramine, and other ions from the fluid. In examples, the carbon material may be configured to absorb or absorb endotoxins and/or bacterial contaminants. The carbon material may be present in the form of a carbon block, or as a free-flowing, granular or powder layer. In some examples, purification module 103 includes an oxide (e.g., a metal oxide such as aluminum oxide) to, for example, remove fluoride and heavy metals from the fluid.

Purification module 103 may include a sorbent and/or resin containing the anion exchange material, the cation exchange material, the carbon material, and/or the metal oxide. In some examples, purification module 103 may include a cartridge holding the sorbent and/or resin. The cartridge can be sized depending on the needs of the user, ranging from a disposable unit that is replaced daily to a larger sized cartridge allowing for production of more medical fluids before the cartridge must be replaced. In some examples, purification module 103 is configured to hold the sorbent and/or resin in another type of container or conduit. In some examples, purification module 103 may include a reverse osmosis module, electrodeionization module, one or more nanofilters, or any other system capable of removing chemical contaminants from the fluid (e.g., water). Purification module 103 may include a microbial filter (e.g., for removal of endotoxins or bacterial contaminants) and/or a particulate filter (e.g., for removal of particulate matter). In examples, purification module 103 is configured to receive the fluid from fluid source 102 and provide a substantially sterile fluid that meets pharmacopoeia requirements related to peritoneal dialysis and/or another medical procedure.

In some examples, system 100 includes a heater 109 configured to heat the fluid. In examples, heater 109 is configured to heat the fluid subsequent to the fluid passing through purification module 103. The fluid may be optionally heated using heater 109 and pumped (e.g., using pump 108 or another pump) to container 104.

Container 104 may include components for use in carrying out peritoneal dialysis. For example, container 104 may initially contain solid material and/or a concentrated liquid solution. Fluid (e.g., purified water) may be pumped into container 104 to dissolve the solid material and/or dilute the concentrated liquid solution. As an example, container 104 may contain sodium chloride, calcium chloride, magnesium chloride, sodium lactate, sodium bicarbonate, and/or a polar and/or an osmotic agent. In certain examples, the osmotic agent can be dextrose or glucose. In some examples, the osmotic agent can be icodextrin and/or another material configured for use as an osmotic agent in peritoneal dialysis therapy. In any example, the components used to generate a medical solution (e.g., a peritoneal dialysis fluid) may be stored in separated containers and then mixed together in container 104.

In examples, system 100 includes a pump 105 configured to cause and/or control a movement of the fluid into and/or out of volume 107 of container 104. Alternatively, or additionally, system 100 may include one or more valves such as a valve 113 configured to control the movement of fluid through system 100. In examples, container 104 is configured to receive the fluid via fluid line 119 fluidically coupled to fluid line 101.

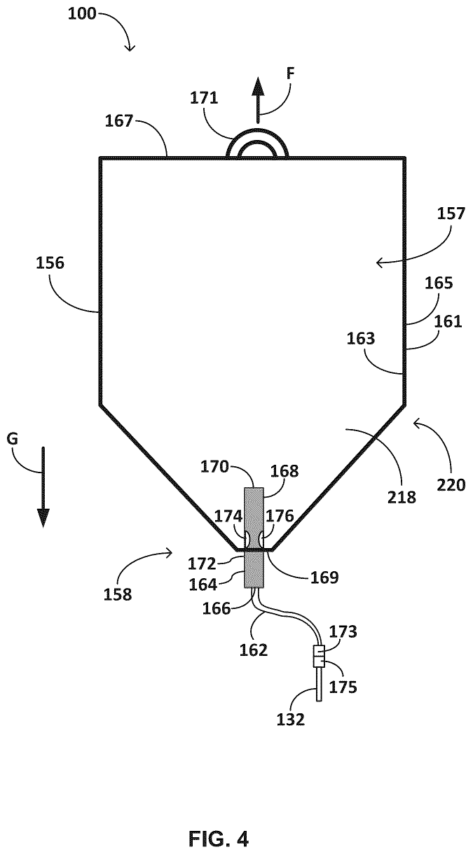

System 100 may include one or mixing devices such as a mixing device 118. Mixing device 118 is configured to promote and/or cause a mixing of the fluid provided to container 104 and at least one component of a medical solution (e.g., a solid concentrate and/or a liquid concentrate). Mixing device 118 is configured to accelerate the fluid as it moves through mixing device 118. In examples, mixing device 118 includes a nozzle section (e.g., nozzle section 172 (FIG. 4)) configured to accelerate the fluid. The acceleration of the fluid may cause a reduction in a pressure (e.g., a static pressure) of the fluid within mixing device 118. Mixing device 118 is configured to use the reduction in pressure to draw the component into the fluid flow flowing through mixing device 118 using a suction port (e.g., suction port 174, 176 (FIG. 4)), such that the fluid flow and the component at least partially mix within mixing device 118. Mixing device 118 may be configured to discharge the fluid flow and the component drawn in through the suction port into container 104 (e.g., container volume 107). In some examples, the suction port is configured to draw in the component from container volume 107 (e.g., container volume 107 may initially hold the component). In some examples, mixing device 118 is configured such that the suction port draws in the component from another container (not shown).

In examples, system 100 includes control circuitry 120 configured to control the one or more pumps (e.g., pump 105, 108) and the one or more valves (e.g., valve 113) of system 100 to generate the medical solution (e.g., a peritoneal dialysis fluid). For example, control circuitry 120 may be configured to cause pump 105, 108 to pump a predetermined volume of fluid (e.g., water) into container 104 to generate the medical fluid. In examples, system 100 may include a flow sensor (not shown) configured to determine an amount (e.g., a volume) of fluid pumped into container 104. In some examples, system 100 may include a scale (not shown) configured to determine an amount (e.g., a mass) of fluid pumped into container 104. Control circuitry 120 may be configured to track the amount of water pumped into container 104 by pump 105, 108 and cause pump 105, 108 to cease pumping when the tracked amount is substantially equal to the predetermined amount.

Control circuitry 120 may be configured to communicate and/or control the pumps, valves, and other components of system 100 using one or more communication links. For example, control circuitry 120 may be configured to communicate with and/or control pump 105 using communication link 121. Control circuitry 120 may be configured to communicate with and/or control pump 108 using communication link 123. Control circuitry 120 may be configured to communicate with and/or control valve 113 using communication link 125. System 100 may include additional communication links configured to communicate with and/or control other components in other examples.

In some examples, system 100 includes one or more sensors such as sensor 111 configured to determine a concentration and/or other parameter of the medical solution within container 104 (e.g., container volume 107). Control circuitry 120 may be configured to communicate with and/or control sensor 111 using communication link 127. Sensor 111 may be used to provide assurance that the concentration and/or other parameter of the medical solution is within a predetermined range. For example, sensor 111 may be a conductivity sensor configured to determine a concentration of ionic components in the medical solution. Alternatively, or additionally, sensor 111 may include a refractive index sensor, polarimetric sensor, or other sensor configured to determine an osmotic agent concentration in the medical fluid.

In examples, system 100 (e.g., control circuitry 120) is configured to assess when dissolution of a solid material and/or dilution of a liquid concentrate is complete. For example, control circuitry 120 may be configured to determine when sensor 111 provides a reading within an acceptable range and assess that the dissolution and/or dilution may be assessed as completed based on the reading. Control circuitry 120 may be configured to determine a variability of readings from the sensor 111 and assess that dissolution and/or dilution is complete when the reading does not fluctuate greater than a predetermined amount.

In some examples, system 100 includes a recirculation line 110 configured to recirculate a medical solution within container volume 107. System 100 (e.g., under the control of control circuitry 120) may be configured to recirculate the medical solution to assist in establishing a homogeneity of the medical solution (e.g., subsequent to production of the medical solution using fluid provided by fluid line 101). For example, prior to an addition of fluid to container 104, container volume 107 may include a component (e.g., a solid concentrate or liquid concentrate). System 100 may be configured to add fluid (e.g., a predetermined amount of fluid) from fluid line 101 to container volume 107 to generate a medical solution comprising the component and the fluid. System 100 may be configured to (e.g., subsequent to adding the predetermined amount of fluid) recirculate the medical solution using recirculation line 110 to assist in establishing a relatively homogenous concentration of the component within the medical solution.

In some examples, control circuitry 120 is configured to assess the concentration of the component to assess a homogeneity of the medical solution. For example, control circuitry 120 may be configured to compare the concentration of the component to a predetermined tolerance range (e.g., stored in a memory of system 100 or another system). If the concentration is outside of the tolerance range, then control circuitry 120 may cause system 100 to recirculate the medical solution using recirculation line 110. Subsequent to the recirculation, control circuitry 120 may be configured to cause system 100 to again determine the concentration of the component and compare concentration to the tolerance range. Control circuitry 120 may be configured to cause system 100 to recirculate the medical solution using recirculation line 110 until the concentration is within the tolerance range.

In some examples, system 100 (e.g., under the control of control circuitry 120) is configured to recirculate the medical solution to assist in establishing a homogeneity of a first component relative to a second component in a medical solution. For example, system 100 may be configured to add fluid (e.g., a predetermined amount of fluid) from fluid line 101 to container volume 107 to generate a medical solution comprising the first component, the second component, and the fluid. System 100 (e.g., control circuitry 120) may be configured to determine a first concentration of the first component and a second concentration of the second component in the medical solution (e.g., subsequent to adding the predetermined amount of fluid). For example, control circuitry 120 may include a first sensor configured to determine the first concentration and a second sensor configured to determine the second concentration. Control circuitry 120 may be configured to cause system 100 to recirculate the medical solution using recirculation line 110 until the first concentration is within a first tolerance range and the second concentration is within a second tolerance range.

In some examples, control circuitry 120 is configured to determine whether the first component and the second component are incorrectly mixed within the medical solution. For example, if, following a predetermined number of recirculations, the first concentration remains outside of the first tolerance range or the second concentration remains outside of the second tolerance range, or if both the first concentration and the second concentration remain outside their respective tolerance ranges, then control circuitry 120 may determine that the first component and/or the second component are mixed improperly (e.g., in improper respective amounts) in the medical solution. In examples, control circuitry 120 is configured to issue an alert in response to assessing the improper mixing, and/or prevent use of the medical solution in subsequent operations of system 100 (e.g., using valve 113 and/or pump 105, 108). For example, control circuitry 120 may cause the disposal of the medical solution stored in container 104.

Although shown in recirculation line 110, sensor 111 and/or additional sensors of system 100 can be placed in fluid line 101 or another portion of system 100.

The amount (e.g., volume or mass) of fluid pumped into container 104 may depend on the amount of a component initially contained within container 104. In certain examples, container 104 contains one or more components required to generate a peritoneal dialysis fluid. The components can be mixed, dissolved, or reconstituted to generate a peritoneal dialysis fluid. In other examples, the components can be separate concentrates added in specific amounts to container 104. The addition of fluid to container 104 to generate a peritoneal dialysis fluid may minimize and/or eliminate a need for pre-mixed fluids, which may ease existing burdens on patients and caregivers. For example, when a 6 liter (L) dialysate container is used, the total weight of the components (e.g., the constituent parts minus the fluid) may be about 325 grams (g) or less, compared to about 6 kilograms (kg) or more for the pre-mixed fluid bag. The volume of storage for a flexible 6L container containing only the components can be about 300-500 cubic centimeters, whereas the pre-mixed fluid bag may be about 6000 cubic centimeters. The smaller size and weights may significantly reduce the space and/or efforts required to store supplies for a peritoneal dialysis treatment.

In some examples, system 100 includes a sterilization module 106. Sterilization module 106 can be any component or set of components capable of substantially sterilizing a medical solution, such as a peritoneal dialysis solution of a liquid component of a peritoneal dialysis solution. System 100 may be configured to pump the medical solution from container 104 (e.g., container volume 107) and through sterilization module 106. In some examples, sterilization module 106 includes one or more ultrafilters. Additionally, or alternatively, sterilization module 106 can include an ultraviolet (UV) light source and/or a microbial filter. Any of the components used in sterilization module 106 may be configured to be replaced as necessary. Alternatively, or additionally, sterilization module 106 can include a flash pasteurization module to sterilize the medical solution. In examples, sterilization module 106 is configured such that a user may adjusting the mode of sterilization based on a mode of use of system 100. For example, a first type of sterilization can be used when the medical solution (e.g., a liquid component of a peritoneal dialysis solution) is generated for later use. A second type of sterilization can be used when the medical solution (e.g., a peritoneal dialysis solution) is generated for immediate use.

System 100 may be configured to pump the medical solution to a container 114 for storage until ready for use by a patient. In some examples, system 100 can be connected to a cycler (not shown) for immediate or later infusion of a peritoneal dialysis fluid comprising the medical solution into a patient. The peritoneal dialysis fluid can be directly infused into the patient after sterilization by connecting fluid line 101 to a catheter. Alternatively, the fluid can be stored in container 114 and subsequently pumped from container 114 and infused into the patient. Although shown in FIG. 1 as fluidically coupled to fluid line 101 by a second fluid line 119 and/or pump 105, in certain examples, container 104 can be placed substantially in-line with fluid line 101. For example, in some examples, container 104 may be directed connected to fluid line 101.

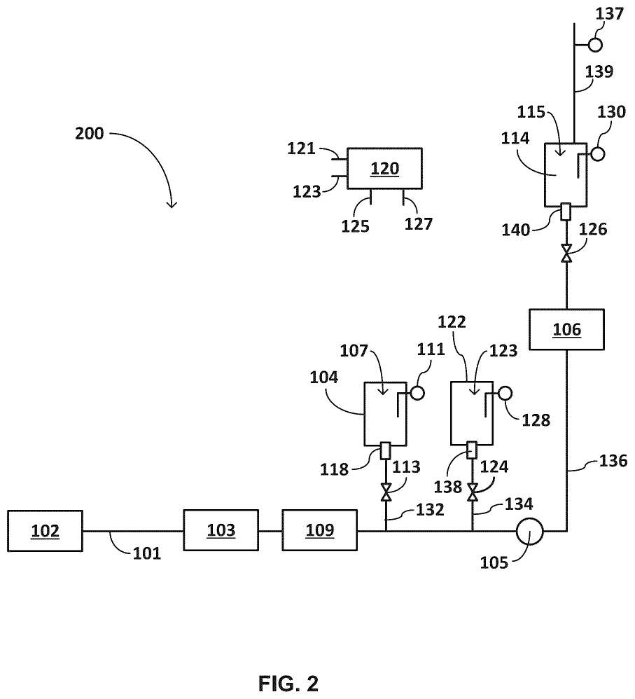

FIG. 2 schematically illustrates an example of another example system 200 configured to generate a medical solution (e.g., a peritoneal dialysis fluid and/or a medical solution comprising a peritoneal dialysis fluid) using container 104, container 114, and a container 122. System 200 is an example of system 100. System 200 includes valve 113 configured to control a flow of fluid through a fluid line 132 fluidically coupling fluid line 101 and container volume 107. System 200 further includes a valve 124 configured to control a flow of fluid through a fluid line 134 fluidically coupling fluid line 101 and a container volume 123 defined by container 122, and a valve 126 configured to control a flow of fluid through a fluid line 136 fluidically coupling fluid line 101 and a container volume 115 defined by container 114. Fluid lines 132, 134, 136 may be an example of fluid line 119 (FIG. 1).

System 200 includes sensor 111 configured to determine a concentration and/or other parameter of a first solution within container 104. In examples, system 200 includes a sensor 128 configured to determine a concentration and/or other parameter of a second solution within container 122. System 200 may include a sensor 130 configured to determine a concentration and/or other parameter of a medical solution (e.g., a peritoneal dialysis fluid) within container 122. Although shown sensor 111 is shown as configured to determine a concentration and/or other parameter within container 104 and/or container volume 107 in FIG. 2, sensor 128 is shown as configured to determine a concentration and/or other parameter within container 122 and/or container volume 123 in FIG. 2, and sensor 130 is shown as configured to determine a concentration and/or other parameter within container 114 and/or container volume 115 in FIG. 2, sensor 111, sensor 128, sensor 130, and/or other sensors of system 200 may be placed in other portions of system 200 in other examples. For example, instead of or in addition to sensor 111, sensor 128, and/or sensor 130, system 200 may include a sensor 137 configured to determine a concentration and/or other parameter of a fluid within a discharge line 139 in fluidic communication with container volume 115.

Container 104 is configured to hold a first component of the medical solution. For example, container 104 may be configured to hold a first concentrate (e.g., a first solid concentrate and/or a first liquid concentrate) comprising a first constituent of the medical solution. System 200 may be configured to produce the first constituent within container volume 107 when a first portion of fluid (e.g., purified water) is provided to mixing device 118 (e.g., via fluid line 132 and/or valve 113). Mixing device 118 may be configured to mix the first portion and the first concentrate and discharge a mixture comprising the first portion and the first constituent into container volume 107. For example, when the first concentrate is a first solid concentrate, mixing device 118 may be configured to mix the first portion and the first solid concentrate to produce a first liquid comprising the first portion and the first constituent.

Container 122 is configured to hold a second component of the medical solution. For example, container 122 may be configured to hold a second concentrate (e.g., a second solid concentrate and/or a second liquid concentrate) comprising a second constituent of the medical solution. System 200 may be configured to produce the second constituent within container volume 123 when a second portion of fluid is provided to a mixing device 138 (e.g., via fluid line 134 and/or valve 124). Mixing device 138 may be configured to mix the second portion and second concentrate and discharge a mixture comprising the second portion and the second constituent into container volume 123. For example, when the second concentrate is a second solid concentrate, mixing device 138 may be configured to mix the second portion and the second solid concentrate to produce a second liquid comprising the second portion and the second constituent.

In some examples, control circuitry 120 is configured to control valves 113, 124, 126 and/or pump 105 such that the first portion of fluid enters container 104. In examples, control circuitry 120 is configured to control valves 113, 124, 126 and/or pump 105 such that the first portion is substantially prevented from entering container 122 and container 114 when the first portion enters container 104. For example, control circuitry 120 may be configured to establish a configuration of system 200 wherein valve 113 is open, valve 124 is shut, and valve 126 is shut when container 104 receives the first portion. In examples, control circuitry 120 is configured to control valves 113, 124, 126 and/or pump 105 such that the second portion of fluid enters container 122. In examples, control circuitry 120 is configured to control valves 113, 124, 126 and/or pump 105 such that the second portion is substantially prevented from entering container 104 and container 114 when the second portion enters container 122. For example, control circuitry 120 may be configured to establish a configuration of system 200 wherein valve 113 is shut, valve 124 is open, and valve 126 is shut when container 122 receives the second portion.

In some examples, the first constituent includes dextrose and/or lactate and the second constituent includes ions (e.g., calcium ions, sodium ions, magnesium ions, and/or chloride ions). In some examples, the first constituent includes ions (e.g., calcium ions, sodium ions, magnesium ions, and/or chloride ions) and the second constituent includes dextrose and/or lactate.

System 200 may be configured to mix the first liquid containing the first constituent and the second liquid containing the second constituent in container 114 to produce the medical solution. For example, system 200 may be configured to deliver the first liquid from container 104 to container 114 (e.g., via fluid line 132, fluid line 101, and fluid line 136 in some examples). System 200 may be configured to deliver the second liquid from container 122 to container 114 (e.g., via fluid line 134, fluid line 101, and fluid line 136 in some examples). In examples, system 200 is configured to deliver the first liquid to container 114 either subsequent to or preceding the delivery of the second liquid to container 114. In some examples, for example when container 104 is configured to receive fluid from fluid line 101 (e.g., via fluid line 132) at a location upstream of where container 122 receives fluid from fluid line 101 (e.g., via fluid line 134), system 200 is configured to deliver the first liquid from container 104 subsequent to the delivery of the second liquid from container 122 to, or example, substantially flush any of the second liquid which may be remaining in fluid line 101 and/or fluid line 136 into container 114.

Control circuitry 120 may be configured to control valves 113, 124, 126 and/or pump 105 to deliver the first liquid to container 114 (e.g., container volume 115). In examples, control circuitry 120 is configured to control valves 113, 124, 126 and/or pump 105 such that the first liquid is substantially prevented from entering container 122 when the first liquid enters container 114. For example, control circuitry 120 may be configured to establish a configuration of system 200 wherein valve 113 is open, valve 124 is shut, and valve 126 is open when container 114 receives the first liquid. In examples, control circuitry 120 is configured to control valves 113, 124, 126 and/or pump 105 to deliver the second liquid to container 114 (e.g., container volume 115). In examples, control circuitry 120 is configured to control valves 113, 124, 126 and/or pump 105 such that the second liquid is substantially prevented from entering container 104 when the second liquid enters container 114. For example, control circuitry 120 may be configured to establish a configuration of system 200 wherein valve 113 is shut, valve 124 is open, and valve 126 is open when container 114 receives the second liquid.

In examples, system 200 is configured to mix the first constituent and the second constituent using a mixing device 140. For example, system 200 may deliver an initial liquid (e.g., one of the first liquid or the second liquid) to container 114 such that such that container volume 115 holds the initial liquid. System 200 may deliver the initial liquid to container volume 115 via mixing device 140. System 200 may deliver a subsequent liquid (e.g., the other of the first liquid or the second liquid) to container 114 via mixing device 140 following the delivery of the initial liquid. Mixing device 140 is configured to cause a mixing of the initial liquid and the subsequent liquid as the subsequent liquid is delivered to container volume 115 via mixing device 140. In examples, system 200 is configured to mix (e.g., further mix) the first constituent and the second constituent with a third liquid in container volume 115. For example, system 200 may be configured to provide the third fluid (e.g., via fluid line 136 and/or mixing device 140) when container volume 115 holds the first constituent and the second constituent. Control circuitry 120 may be configured to control valves 113, 124, 126 and/or pump 105 to deliver the third liquid to container 114 (e.g., container volume 115).

For example, mixing device 140 may be configured such that one or more suction ports defined by mixing device 140 are fluidically coupled to and/or positioned within container volume 115 as container 114 holds the initial liquid and/or holds an initial solid. Mixing device 140 is configured to cause an acceleration of the subsequent liquid (e.g., using a nozzle section) as the subsequent liquid moves through mixing device 140. The acceleration of the subsequent liquid may reduce a pressure (e.g., a static pressure) of the subsequent fluid, causing a suction port of mixing device 140 to draw some portion of the initial liquid and/or initial solid within container volume 115 into the subsequent liquid passing through mixing device 140. Hence, mixing device 140 may cause the initial liquid and/or initial solid and the subsequent liquid to at least partially mix within mixing device 140. Mixing device 140 may discharge the at least partially mixed initial liquid and/or initial solid and subsequent liquid into container volume 115. Further mixing of the initial liquid and/or initial solid and the subsequent liquid may occur within container volume 115 at least partially as a result the discharge of mixing device 140 into container volume 115. For example, the discharge of mixing device 140 into container volume 115 may cause further agitation of the initial liquid and/or initial solid and the subsequent liquid within container volume 115, causing additional mixing of the initial liquid and/or initial solid and the subsequent liquid within container volume 115.

System 200 may be configured to produce a medical solution in container 114 comprising a particular amount of the first liquid and a particular amount of the second liquid. In examples, the medical solution may comprise a particular amount of the fluid. Control circuitry 120 may be configured to cause system 200 to deliver the particular amount of the first liquid from container 104 to container 114, deliver the particular amount of the second liquid from container 122 to container 114, and/or deliver the particular amount of fluid from fluid source 102 to container 114.

In some examples, control circuitry 120 is configured to assess a mixing of the first liquid, the second liquid, and/or the fluid within container volume 115 based on a signal received from sensor 130, which is indicative of a composition of the solution in volume 115. For example, control circuitry 120 may be configured to determine when sensor 130 provides a reading within an acceptable range and determine that mixing of the first liquid, the second liquid, and/or the fluid is sufficiently complete based on the reading. In some examples, control circuitry 120 is configured to determine a variability of readings from the sensor 130 and assess that the mixing of the first liquid, the second liquid, and/or the fluid is sufficiently complete when the reading does not fluctuate greater than a predetermined amount. In some examples, control circuitry 120 may cause system 200 to adjust the mixture in container 114 based on the reading from sensor 130, such as by causing further amounts of the first liquid, the second liquid, and/or the fluid to be adding to volume 115 of container 114 based on the reading from sensor 130.

In some examples, container 114 and/or container 122 includes a dedicated recirculation line configured to recirculate a mixture within container volume 115 or container volume 123. The dedicated recirculation line may be configured within respect to container 114 and/or container 122 in the same manner as the configuration of recirculation line 110 with respect to container 104. System 200 (e.g., control circuitry 120) may be configured to recirculate a medical solution within container volume 115 and/or container volume 123 to assist in establishing a homogeneity of the medical solution. In examples, system 200 (e.g., control circuitry 120) is configured to recirculate the medical solution using the dedicated recirculation line based on a reading from sensor 130 and/or a reading from sensor 128. System 200 (e.g., control circuitry 120) may be configured to recirculate a medical solution using the dedicated recirculation line and based on the reading from sensor 130, 128 in a similar manner and/or using similar criteria as the recirculation of a medical solution using recirculation line 110 based on a reading from sensor 111.

Containers 104, 114, 122 can each have any suitable configuration. In some examples, one or more of container 104, 114 or 122 is a reusable sterilized container or bag. The reusable container or bag can be cleaned and sterilized daily, or at set time periods. System 200 and/or container 104, 114, 122 may include one or more connectors (not shown) configured to allow removal of container 104, 114, 122 from system 200. The connectors may be any type of connector configured to allow removal of container 104, 114, 122 from system 200. In certain examples, one or more of the containers 104, 114, 122 may be a rigid container of fixed volume, such as a stainless-steel or rigid plastic container. If a rigid container is used, a vent (not shown) can be added to let air exit container 104, 114, 122 as a fluid enters container 104, 114, 122. The vent may include a sterile filter to avoid contaminations from the external environment.

System 200 may optionally contain a level sensor and/or a weight sensor (not shown) configured to indicate when the rigid container may be filled. Control circuitry 120 may be configured to detect when a proper volume of fluid has been added to the rigid container based on a signal from the level sensor (e.g., a signal indicative of the level within a container volume defined by the rigid container). In some examples, container 104, 114, 122 may be a flexible and semi-compliant design that minimizes the volume required for storage prior to use. In some examples, container 104, 114, 122 may include one or more components to increase a rate of dissolution of a solid material and/or rate of dilution of a liquid material. For example, container 104, 114, 122 may include stir bars or other components to increase the rate of dissolution and/or the rate of dilution (e.g., when container 104, 114, 122 is placed on an external mixing apparatus).

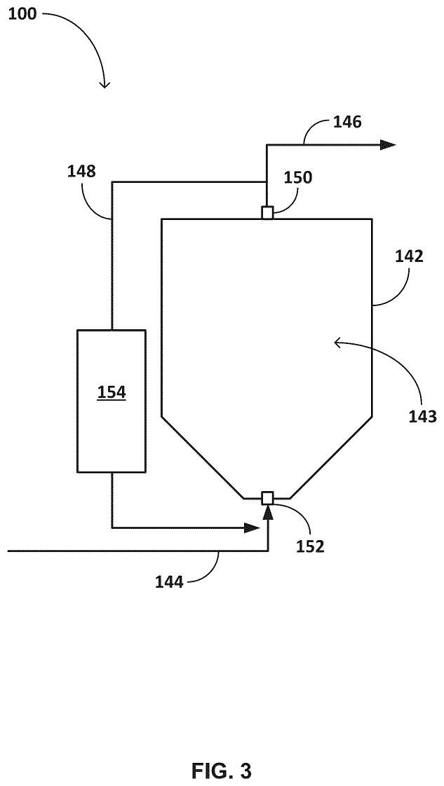

FIG. 3 is a schematic flow diagram using an example container 142, a fluid line 144, a fluid line 146, and a recirculation line 148. Container 142 defines a container volume 143. Container 142 may be an example of any of the containers 104, 114, 122 of FIGS. 1 and 2. Container volume 143 may be an example of container volume 107, 115, 123. Fluid line 144 may be an example of fluid line 101, 132, 134, 136. Fluid line 146 may be an example of fluid line 101 or another fluid line of system 100, 200. Recirculation line 148 may be an example of recirculation line 110.

Fluid line 144 is configured to be fluidly connected to a water source (e.g., fluid source 102 (FIG. 1)) and a water purification module (e.g., purification module 103 (FIG. 1)). In examples, fluid line 144 is fluidically coupled to container inlet 152 of container 142. In some examples, fluid line 144 can be fluidly connected to a purified water source, and purification module 103 (FIG. 1) can be omitted. In some examples, container 142 may include a mixing device (e.g., mixing device 118, 138, 140, 158, 202) attached to container inlet 152 and/or in fluidic communication with container volume 143.

Fluid (e.g., water) can be pumped into container 142 to dissolve solid material or dilute a concentrated solution inside container volume 143, generating a constituent of a medical solution or a medical solution (e.g., a peritoneal dialysis fluid or a medical solution intended to comprise a peritoneal dialysis fluid). The medical solution can be pumped out of container 142 through fluid line 146 for sterilization and use. In some examples, sterilization module 106 (FIG. 1) can be upstream of container 142, and the medical solution can be used without further sterilization.

In examples, recirculation line 148 can be included, optionally with a pump (not shown). Recirculation line 148 is configured to allow medical solution exiting container volume 143 from a container outlet 150 of container 142 to be recirculated back to container volume 143 via a container inlet 152 of container 142 (e.g., for dissolution, reconstitution, dilution, and/or mixing). Optionally, a heater 154 can be included in recirculation line 148. Heater 154 may be configured to establish and/or maintain a temperature of the medical solution near a body temperature, making delivery of the medical solution (e.g., a peritoneal dialysis fluid) to the patient more comfortable. Although shown as positioned in recirculation line 148, the heater 154 can also be positioned in fluid line 144 or heater 109 (FIG. 1) may be omitted.

Although FIG. 3 illustrates fluid line 144 and/or container inlet 152 connected to a bottom of container 142 and fluid line 146 and/or container outlet 150 connected to a top of container 142, in some examples, a single connector can be used as both container inlet 152 and container outlet 150. System 100, 200 can also include one or more pumps and/or one or more valves to control fluid movement through fluid lines 144, 146, 148 and into and out of container 142. Control system 120 (FIG. 1, FIG. 2) may be configured to control the pumps and valves to add a predetermined volume of water into container 142 to generate a medical solution (e.g., a peritoneal dialysis fluid) having a specified concentration of one or more components of the medical solution.

FIG. 4 illustrates an example of an example container 156 with a mixing device 158 configured to act as a mixing element for dissolution and/or dilution of solid or liquid material. Container 156 defines a container volume 157. Mixing device 158 is fluidically coupled to a fluid line 162. Container 156 may be an example of any container described herein, including containers 104, 114, 122 and/or 142. Container volume 157 may be an example of container volume 107, 115, 123, 143. Mixing device 158 may be an example of mixing device 118, 138, 140. Fluid line 162 may be an example of fluid line 101, 132, 134, 136, 144.

Container 156 is configured to initially contain (e.g., within container volume 157) a component of the medical solution, such as a solid powder and/or a liquid concentrate. Mixing device 158 is configured to receive a fluid (e.g., water) and discharge the fluid into container volume 157. In examples, mixing device 158 is configured to be directly or indirectly connected to fluid line 162. Container 156 and/or mixing device 158 may be configured such that the fluid may dissolve the solid powder and/or dilute the liquid concentrate. In examples, mixing device 158 includes an inlet section 164 defining a device inlet 166 configured to receive the fluid (e.g., from fluid line 162), an outlet section 168 defining a device outlet 170 configured to discharge the fluid (e.g., to container volume 157), and a nozzle section 172 fluidly coupling device inlet 166 and device outlet 170.

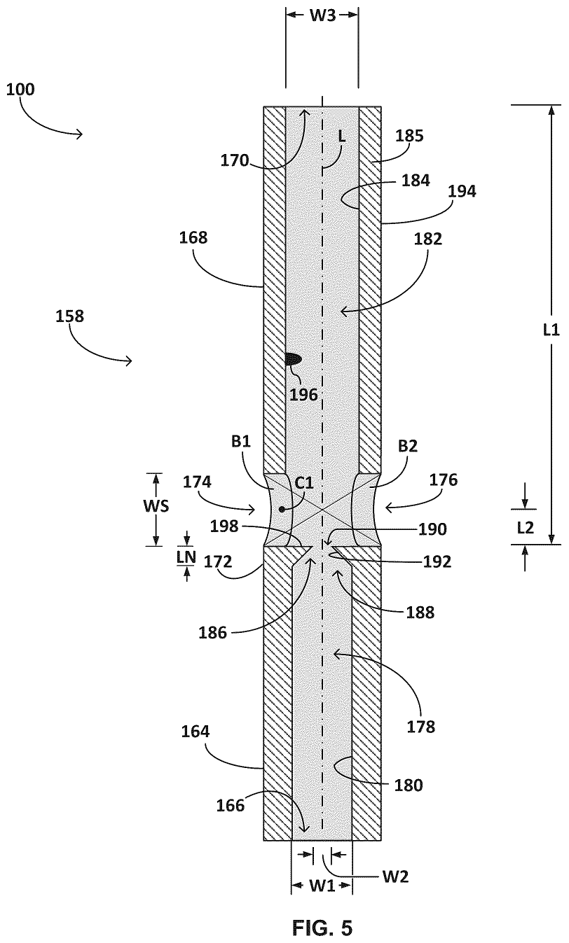

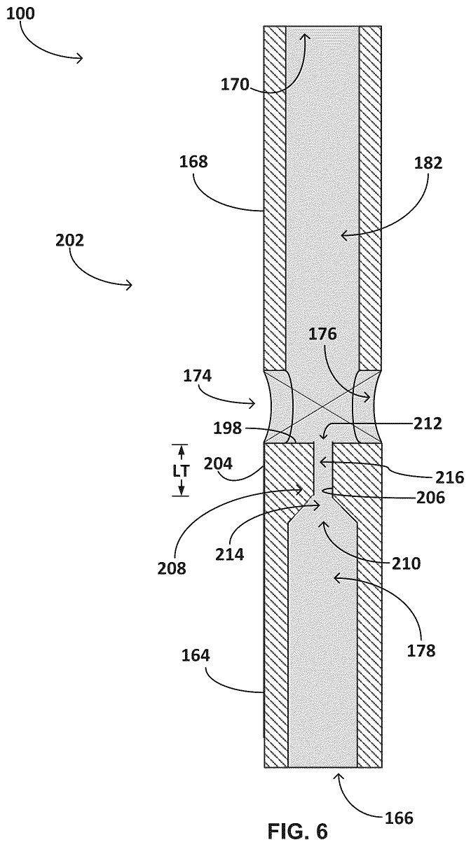

Nozzle section 172 is configured to accelerate (e.g., increase a velocity of) the fluid as the fluid flows from device inlet 166 to device outlet 170. In examples, nozzle section 172 defines an inwardly tapering diameter or width to constrict a flow area of the fluid as the fluid flows from device inlet 166 to device outlet 170. Nozzle section 172 is configured to cause a reduction in pressure (e.g., a static pressure) of the fluid as the fluid flows through nozzle section 172 (e.g., as the fluid flows through the tapering section). In examples, mixing device 158 is configured such that a fluid received at device inlet 166 flows through an inlet passage (e.g., inlet passage 178 (FIG. 5, FIG. 6)) defined by inlet section 164, from the inlet passage into a nozzle passage (e.g., nozzle passage 186 (FIG. 5), nozzle passage 208 (FIG. 6)) defined by nozzle section 172, from the nozzle passage into an outlet passage (e.g., outlet passage 182 (FIG. 5, FIG. 6)) defined by outlet section 168, and from the outlet passage through device outlet 170.

Mixing device 158 defines one or more suction ports such as suction port 174 and/or suction port 176. Suction port 174, 176 is configured to fluidically couple container volume 157 and the outlet passage of outlet section 168. In examples, mixing device 158 is configured to cause suction port 174, 176 to draw the component (e.g., the solid powder and/or a liquid concentrate) stored in container volume 157 into the outlet passage using a suction caused by the reduction in pressure of the fluid flowing through mixing device 158. In examples, mixing device 158 is secured (e.g., attached or welded to) container 156. In some examples, mixing device 158 is secured to container 156 such that suction ports 174, 176 and device outlet 170 is within container volume 157 and device inlet 166 is outside of container volume 157.

In the example shown in FIG. 4, container 156 includes a body 161 (“container body 161”) defining an inner surface 163 (“container inner surface 163”) and an outer surface 165 (“container outer surface 165”) opposite container inner surface 163. In examples, container inner surface 163 defines a boundary of container volume 157. In examples, container body 161 defines a top 167 (“container top 167”) at a first end of container body 161 and a defines a bottom 169 (“container bottom 169”) at a second end of container body 161 opposite the first end.

Container 156 may be configured such that container top 167 is displaced from container bottom 169 in a direction opposite a gravity vector G acting on container body 161 when container volume 157 holds a component (e.g., a solid concentrate and/or a liquid concentrate) intended to comprise a medical solution and/or holds the medical solution. In examples, container top 167 is displaced from container bottom 169 in the direction opposite gravity vector G when container 156 is positioned in system 100 as intended. In some examples, container 156 is configured to engage a component (e.g., bracket, a tray, and/or other component) of system 100 to cause container top 167 to be displaced from container bottom 169 in the direction opposite gravity vector G when container volume 157 holds the component and/or the medical solution. For example, container 156 may be configured to displace top 167 from container bottom 169 in the direction opposite gravity vector G when the component (e.g., the bracket, tray, and/or other component) of system 100 imparts a force F opposite gravity vector G on 156 (e.g., when the component imparts force F on container bottom 169 and/or another portion of container body 161). In some examples, container 156 includes a hanger member 171 secured to container top 167 and configured to cause container top 167 to be displaced from container bottom 169 when the force F is imparted on hanger member 171.

The reduction in pressure caused by nozzle section 172 as fluid flows from device inlet 166 to device outlet 170 creates a low pressure zone in mixing device 158. Mixing device 158 is configured such that a material (e.g., a component of a medical solution) adjacent to suction port 174, 176 is drawn into the fluid flowing through mixing device 158. In examples, mixing device 158 is configured relative to container 156 such that suction port 174, 176 are positioned at or in proximity to container bottom 169 (e.g., as depicted in FIG. 4). The suction created by the reduction in pressure of the fluid may cause suction ports 174, 176 to draw in material such as dry powder which resides in proximity to container bottom 169. Mixing device 158 may be configured such that a mixture of fluid and the component is discharged through device outlet 170 (e.g., discharged into container volume 157). Mixing device 158 may be configured to cause at least some degree of mixing of the fluid and the component within outlet section 168 in the absence of separate mechanical agitation of mixing device 158.

Suction ports 174, 176 may be downstream of nozzle section 172 at any suitable position on outlet section 168. Mixing device 158 may include any number of suction ports. For example, in some examples, mixing device 158 defines one suction port or more than two suction ports, such as up to six or more suction ports. Mixing device 158 is configured such that the suction ports are fluidically coupled to (e.g., open into) container volume 157 when mixing device 158 is properly attached to container 156. Hence, material inside container volume 157 can be drawn in through suction port 174, 176 positioned in the vicinity of a low-pressure zone created by nozzle section 172 as the fluid flows from device inlet 166 to device outlet 170. A mixture of the material and the fluid can exit device outlet 170 and enter container volume 157.

In examples, mixing device 158 may be positioned at or near container bottom 169 in a substantially upright position. Mixing device 158 may be configured such that a direction from device inlet 166 to device outlet 170 is substantially parallel (e.g., parallel or nearly parallel to the extent permitted by manufacturing tolerances) to a direction from container bottom 169 to container top 167 when mixing device is in the upright position. In examples, mixing device 158 is secured to container 156 (e.g., secured to container body 161). In examples, mixing device 158 is positioned such that mixing device enters container volume 157 substantially through container bottom 169. In examples, container 156 is configured such that a fluid discharged through mixing device 158 into container volume 157 forms a fluid body in contact with mixing device 158 when gravity vector G acts on container 156. In examples, mixing device 158 is configured to discharge the fluid from device outlet 170 is a direction from container bottom 169 towards container top 167.

Mixing device 158 may be configured relative to container volume 157 such that the discharge of the mixture of the fluid and the component into container volume 157 causes a circulation of and/or an agitation of a fluid body within container volume 157. The fluid body within container volume may be, for example, an amount of the mixture previously discharged through device outlet 170. The circulation of and/or agitation caused by the discharge may promote further mixing of the fluid and the component within container volume 157. In some examples, mixing device 158 may be configured to draw in some portion of the fluid body within container volume 157 via suction holes 174, 176 as fluid flows from device inlet 166 to device outlet 170.

For example, a first portion of fluid (“first fluid portion”) may flow from device inlet 166 and through nozzle section 172, causing suction ports 174, 176 to draw in a first portion of a material (“first material portion”) within container volume 157. Outlet section 168 may cause at least some degree of mixing of the first fluid portion and the first material portion to produce a portion mixture comprising the first fluid portion and the first material portion. Outlet section 168 may discharge the portion mixture into container volume 157. Circulation and/or agitation of the portion mixture within container volume 157 may cause further mixing of the fluid portion and the material portion, and/or cause mixing of the portion mixture with other portion mixture present within container volume 157. In examples, mixing device 158 is positioned relative to and/or secured to container 156 in the upright position to, for example, promote and/or enhance circulation and/or agitation of the mixture portion within container volume 157 (e.g., as device outlet 170 discharges additional mixture portions).

In examples, mixing device 158 and/or container body 161 are configured to allow the portion mixture to discharge from device outlet 170 and substantially recirculate back to outlet section 168 using suction ports 174, 176. For example, mixing device 158 may be configured such that device outlet 170 discharges the portion mixture into container volume 157 and suction ports 174, 176 draw material into outlet section 168 from container volume 157. Hence, mixing device 158 may initially discharge the portion mixture into container volume 157. Mixing device 158 may subsequently receive a second portion of fluid (“second fluid portion”) which flows from device inlet 166 and through nozzle section 172. The flow of the second fluid portion through nozzle section 172 may cause suction ports 174, 176 to draw in some part of the portion mixture within container volume 157 that was previously discharged via device outlet 170, causing at least some degree of mixing of the second fluid portion and the portion mixture (and, e.g., any additional material drawn through suction ports 174, 176). Hence, mixing device 158 and/or container body 161 may be configured to cause some degree of recirculation of a portion mixture discharged via device outlet 170 to promote more complete mixing and/or homogeneity of a medical solution produced within container volume 157.

In examples, container body 161 and/or container volume 157 are configured to guide material within container volume 157 towards suction ports 174, 176. For example, container body 161 and/or container volume 157 may be configured to funnel and/or guide the material toward a region of container volume 157 which contains suction ports 174, 176. In examples, container body 161 and/or container volume 157 define surfaces configured to funnel and/or guide the material toward the region of container volume 157 when the material is subject to gravity vector G. For example, container body 161 and/or container volume 157 can be shaped to funnel and/or guide the material toward container bottom 169 when mixing device 158 is secured to (e.g., extends through) container bottom 169.

Fluid line 162 is configured to be connected to and/or connectable to a peritoneal dialysis fluid generation system (not shown) for generation of and/or use of peritoneal dialysis fluid using the component within container volume 157. Mixing device 158 may extend inwardly into container volume 157 and include any configuration intended to induce a low-pressure zone after constriction in nozzle section 172. Fluid line 162 may be coupled to (e.g., attached to) mixing device 158, such that a fluid delivered by fluid line 162 enters device inlet 166. In some examples, fluid line 162 may be a flexible fluid line (e.g., flexible tubing). In some examples, fluid line 162 may be a fluid line configured to be a substantially fixed fluid line of system 100.

In some examples, container 156 includes a connector 173 configured to fluidically couple fluid line 162 and a fluid line of system 100 such as fluid line 132. Connector 173 may be configured to mechanically engage a second connector 175 of system 100 to fluidically couple the fluid line of system 100 and container volume 157 (e.g., via mixing device 158). Connector 173 may be configured to mechanically engage and/or mechanically disengage with second connector 175. For example, connector 173 may be configured to mechanically engage and/or mechanically disengage with second connector 175 when connector 173 is rotated relative to second connector 175, when connector 173 experiences a force causing a displacement of connector 173 toward or away from second connector 175 (e.g., when connector 173 is pushed or pulled), or when connector 173 is manipulated in some other way relative to second connector 175. Connector 173 may be configured to mechanically disengage from second connector 175 to, for example, separate container 156 and the fluid line of system 100 (e.g., fluid line 132). In examples, container 156 includes fluid connector 173 and mixing device 158 as a substantially integrated unit, such that container 156, fluid connector 173, and mixing device 158 may be mechanically disengaged from a remainder of system 100 for disposal or other reasons.

FIG. 5 is a cross-sectional schematic illustration of an example mixing device 158 defining a longitudinal axis L, with a cutting plane taken parallel to longitudinal axis L. Mixing device 158 includes inlet section 164 defining device inlet 166 and an inlet passage 178. Device inlet 166 opens into inlet passage 178. In examples, an inner surface 180 of inlet section 164 (“inlet section inner surface 180”) defines a boundary of inlet passage 178. Mixing device 158 includes outlet section 168 defining device outlet 170 and an outlet passage 182. In examples, an inner surface 184 of outlet section 168 (“outlet section inner surface 184”) defines a boundary of outlet passage 182. Outlet section inner surface 184 may be a surface defined by a boundary wall 185 of outlet section 168. Device outlet 170 opens into outlet passage 182. In examples, inlet section inner surface 180 and/or outlet section inner surface 184 surround longitudinal axis L. In examples, longitudinal axis L intersects (e.g., passes through) device inlet 166, inlet passage 178, outlet passage 170, and/or device outlet 170.

Mixing device 158 includes nozzle section 172 defining a nozzle passage 186. Nozzle section 172 may be configured such that nozzle passage 186 fluidically couples inlet passage 178 and outlet passage 182. In examples, nozzle section 172 defines a nozzle inlet 188 and a nozzle outlet 190. Nozzle passage 186 may extend from nozzle inlet 188 to nozzle outlet 190. In examples, nozzle inlet 188 opens into inlet passage 178. In examples, nozzle outlet 190 opens into outlet passage 182. In examples, an inner surface 192 of nozzle section 172 (“nozzle section inner surface 192”) defines a boundary of nozzle passage 186.

Nozzle section 172 is configured to cause an acceleration of a fluid as the fluid flows from nozzle inlet 188 to nozzle outlet 190. In examples, nozzle section 172 is configured to constrict a flow area available to the fluid as the fluid flows from nozzle inlet 188 to nozzle outlet 190 to cause the acceleration. In examples, the flow area is an area or volume defined between nozzle inlet 188 and nozzle outlet 190 and substantially traverse (e.g., substantially perpendicular) to a direction of a fluid flowing from nozzle inlet 188 to nozzle outlet 190. In examples, nozzle section inner wall defines a boundary of the flow area. Nozzle section 172 may be configured such that an area of the flow area decreases as the flow area moves in a direction from nozzle inlet 188 to nozzle outlet 190. Nozzle section 172 is configured to cause a pressure (e.g., a static pressure) of the fluid to decrease due to the acceleration of the fluid as the fluid flows from nozzle inlet 188 to nozzle outlet 190.

In examples, nozzle section inner surface 192 tapers inwardly (e.g., toward longitudinal axis L) as nozzle section inner surface 192 extends from nozzle inlet 188 to nozzle outlet 190. In examples, nozzle section 172 is configured such that a width W1 of nozzle inlet 188 is greater than a width W2 of nozzle outlet 190. In examples, width W1 is a cross-sectional dimension (e.g., a diameter) of nozzle inlet 188 defined perpendicular to longitudinal axis L. In examples, width W2 is a cross-sectional dimension (e.g., a diameter) of nozzle outlet 190 defined perpendicular to longitudinal axis L. Width W1 and/or width W2 may be substantially traverse (e.g., perpendicular or nearly perpendicular) to a direction of a fluid flowing from nozzle inlet 188 to nozzle outlet 190. In examples, width W2 is less than or equal to about 30% of width W1. In some examples, width W2 is about 1 millimeter (mm) and width W1 is about 4 mm, but the specific dimensions may vary depending on the particular application of mixing device 158.

Nozzle outlet 190 is configured to create a low-pressure zone in outlet section 168 (e.g., in outlet passage 182) due to the reduction in pressure of the fluid flowing through nozzle section 172. In examples, as fluid flow exits nozzle outlet 190 and enters outlet passage 182, an expansion of the flow area available to the fluid exiting nozzle outlet 190 causes the low-pressure zone. For example, in examples, outlet section 168 may define a width W3 greater than width W2. The expansion of the flow area as the fluid flow transitions from a flow area defined by width W2 (e.g., at nozzle outlet 190) to a flow area defined by width W3 may cause the fluid flow to create the low-pressure zone.

In examples, nozzle section inner surface 192 tapers inwardly (e.g., toward longitudinal axis L) as nozzle section inner surface 192 extends from nozzle inlet 188 to nozzle outlet 190. In examples, nozzle section 172 is configured such that a width W1 of nozzle inlet 188 is greater than a width W2 of nozzle outlet 190. In examples, width W1 is a cross-sectional dimension (e.g., a diameter) of nozzle inlet 188 defined substantially perpendicular to longitudinal axis L. In examples, width W2 is a cross-sectional dimension (e.g., a diameter) of nozzle outlet 190 defined substantially perpendicular to longitudinal axis L. Width W1 and/or width W2 may be substantially traverse (e.g., substantially perpendicular) to a direction of a fluid flowing from nozzle inlet 188 to nozzle outlet 190.

Nozzle outlet 190 is configured to create a low-pressure zone in outlet section 168 (e.g., in outlet passage 182) due to the reduction in pressure of the fluid flowing through nozzle section 172. In examples, as fluid flow exits nozzle outlet 190 and enters outlet passage 182, an expansion of the flow area available to the fluid exiting nozzle outlet 190 causes the low pressure zone. For example, in examples, outlet section 168 may define a width W3 greater than width W2. The expansion of the flow area as the fluid flow transitions from a flow area defined by width W2 (e.g., at nozzle outlet 190) to a flow area defined by width W3 may cause the fluid flow to create the low-pressure zone.

Outlet section 168 defines suction port 174 and/or suction port 176. Suction port 174, 176 may be a passage passing through boundary wall 185. In examples, suction port 174,176 extends from outlet passage inner surface 184 to an outer surface 194 of outlet section 168 (“outlet section outer surface 194”). Outlet section outer surface 194 may be a surface defined by boundary wall 185 and opposite outlet section inner surface 180. In examples, suction port 174, 176 opens to outlet section outer surface 194 and outlet section inner surface 180. Boundary wall 185 may define a boundary of suction port 174, 176. For example, boundary wall 185 may define a boundary B1 of suction port 174. Boundary wall 185 may define a boundary B2 of suction port 176. In examples, boundary B1 extends from outlet section inner surface 184 to outlet section outer surface 194 and/or boundary B2 extends from outlet section inner surface 184 to outlet section outer surface 194.

In examples, outlet section 168 is configured to create and/or enhance a turbulence of a fluid flow flowing through outlet passage 182. Outlet section 168 may be configured to create and/or enhance the turbulence to cause at least some degree of mixing between a fluid discharging from nozzle outlet 190 and a material drawn in through suction ports 174, 176. In examples, outlet section 168 (e.g., outlet section inner surface 180) defines one or more protrusions (e.g., internal ridges or screw features) such as protrusion 196 positioned along a length of outlet section inner surface 180 to encourage mixture of the fluid and the material. The one or more protrusions may increase a mixing of the fluid and the material in outlet section 168 as compared to mixing devices which lack similar protrusions. Protrusion 196 may be configured to extend from outlet section inner surface 180 in a direction toward outlet passage 182 and/or longitudinal axis L. In examples, protrusion 196 is configured to prevent a flow obstruction to the fluid and/or material flowing through outlet passage 182, such that the fluid and/or material is forced to change its flow direction when it encounters protrusion 196.

In examples, outlet section 168 defines a wall surface 198 configured to cause the flow area available to the fluid discharging through nozzle outlet 190 to expand from width W2 defined by nozzle outlet 190 to width W3 defined by outlet section 168. Mixing device 158 may be configured such that nozzle outlet 190 opens to wall surface 198. In examples, wall surface 198 extends in a direction substantially perpendicular to longitudinal axis L. In examples, wall surface 198 extends from nozzle outlet 190 to outlet section inner surface 184. In some examples, wall surface 198 defines a boundary of nozzle outlet 190. Hence, in some examples, nozzle outlet 190 may substantially define an orifice in wall surface 198 configured to discharge a fluid into a volume (e.g., outlet passage 186) defined by wall surface 198 and outlet section inner surface 184.

Outlet section 168 may be configured such that outlet passage 186 extends from wall surface 198 to device outlet 170. Mixing device 158 may be configured such that a relatively abrupt expansion of a flow area available to the fluid (e.g., an expansion from a flow area defined by nozzle outlet 190 to a flow area defined by wall surface 198 and outlet section inner surface 184) as the fluid enters outlet passage 186 enhances the suction through suction ports 174, 176 in outlet section 168. Enhancing the suction through suction ports 174, 176 may enhance the movement of material through suction ports 174, 176 and into outflow passage 182. This may facilitate efficient mixing of the fluid and the material as the fluid and material move through mixing device 158.

In some examples, suction ports 174, 176 extend through boundary wall 185 at locations in relatively close proximity to wall surface 198 to enhance the suction through suction ports 174, 176. For example, in some examples, mixing device 158 (e.g., outlet section 168) defines a first length L1 from wall surface 198 to device outlet 170. Mixing device 158 (e.g., outlet section 168) may define a second length L2 from wall surface 198 to a centroid defined by a boundary of a suction port (e.g., centroid C1 defined by boundary B1). Length L2 may be less than or equal to about 50% of length L1 in some examples. In some examples, length L2 is less than or equal to about 30% of length L1. In some examples, length L2 is less than or equal to about 10% of length L1. In some examples, a shortest distance from wall surface 198 to boundary B1 is less than or equal to about 50% of length L1 in some examples, less than or equal to about 30% of length L1 in some examples, and/or less than or equal to about 10% of length L1 in some examples. In some examples, boundary B1 substantially extends from wall surface 198. In some examples, some portion of boundary B1 is coincident with a portion of wall surface 198 (e.g., wall surface 198 may comprise some portion of boundary B1). As used here and elsewhere, when a quantity is “about” a specified percentage, this may mean the quantity is within plus or minus 5% of the specified percentage.

In some examples, outlet section 168 (e.g., outlet section inner wall 184) is configured to define width W3 substantially over the length L1. For example, in some examples, outlet section 168 may define a substantially constant cross-sectional area (e.g., substantially perpendicular to longitudinal axis L) of outlet passage 182 over some portion of or substantially all of length L1. In some examples, width W3 is a diameter and outlet section 168 defines a substantially tubular section (e.g., tubular or nearly tubular to the extent permitted by manufacturing tolerances). In some examples, outlet section 168 (e.g., outlet section inner wall 184) may be configured such that outlet passage 182 diverges as outlet passage 182 extends in a direction from nozzle outlet 190 to device outlet 170. Outlet passage 182 may be configured to diverge as outlet passage extends toward device outlet 170 to allow for a controlled deceleration of the fluid and/or the materials drawn into the fluid via suction ports 174, 176. In examples, when outlet passage diverges, outlet section 168 (e.g., outlet section inner surface 184) define a cross-sectional area (e.g., substantially perpendicular to longitudinal axis L) of outlet passage 182 which increases as outlet passage extends toward device outlet 170. In some examples, outlet passage 182 is configured to diverge downstream of suction ports 174, 176 when a fluid flows from nozzle outlet 190 to device outlet 170.

In some examples, inlet section 164 (e.g., inlet section inner wall 180) defines width W1 substantially over a length from device inlet 166 to nozzle inlet 188. For example, in some examples, inlet section 164 may define a substantially constant cross-sectional area (e.g., substantially perpendicular to longitudinal axis L) of inlet passage 178 over some portion of or substantially all of the length from device inlet 166 to nozzle inlet 188. In some examples, width W1 is a diameter and inlet section 164 defines a substantially tubular section. In some examples, inlet section 164 may be configured to receive some portion of a fluid line (e.g., fluid line 132, 134, 136, 144, 162) to, for example, couple (e.g., mechanically couple) inlet section 164 and the fluid line. For example, inlet section 164 may define an entry width greater than the width W1. The entry width may be configured to allow inlet section 164 to receive the portion of the fluid line. Inner section inner surface 180 may be configured to transition from the entry width to width W1. In some examples, inner section inner surface 180 substantially defines a step (e.g., a cylindrical step) when inner section inner surface 180 transitions from the entry width to width W1.

Dimensions of mixing device 158 may have any value either alone or relative to other dimension to enhance the design and functionality of mixing device 158. For example, mixing device 158 may be configured (e.g., dimensioned) such that a fluid entering nozzle inlet 188 and/or flowing through inlet passage 178 tends to have a Reynolds number of at least 2300 to, for example, enhance a propensity of turbulent flow. Causing the Reynolds number to be greater than 2300 may promote fluid flow that is sufficiently agitated to enhance subsequent mixing. In some examples, mixing device 158 is configured (e.g., dimensioned) such that a fluid discharging from nozzle outlet 190 and/or flowing through outlet passage 182 tends to have a Reynolds number of at least 4000 to, for example, enhance turbulent flow. The turbulent flow at nozzle outlet 190 and/or within outlet passage 182 may limit flow separations and enhance a substantially consistent fluid velocity.

In some examples, width W3 is greater than width W1 to facilitate increased mass flow rates and/or reduce a hydraulic resistance of mixing device 158. In some examples, mixing device 158 is configured to (e.g., dimensioned) to cause a pressure differential from nozzle inlet 188 to nozzle outlet 190 of less than about 0.6 bar, in some examples less than or equal to about 0.4 bar. Limiting this pressure differential may limit fluid pressures required elsewhere within system 100 (e.g., to safeguard against overpressure) such as fluid pressures in portions of system 100 upstream of mixing device 158 and/or container 156. In some examples, mixing device 158 is configured to (e.g., dimensioned) allow and/or cause a flow rate through mixing device 158 of greater than or equal to about 200 ml/min, in some examples greater than or equal to about 400 mL/min to, for example, reduce a time required and enhance efficiency when producing a medical solution within container volume 157.

Configuring (e.g., dimensioning) mixing device 158 to meet one or more of the thresholds discussed above and elsewhere may be based on or more properties of the fluid expected to flow through mixing device 158. For example, configuring (e.g., dimensioning) mixing device 158 to meet one or more of the thresholds may be predicated on a density of the fluid, a viscosity of the fluid (e.g., a kinematic and/or dynamic viscosity), and/or other fluid properties. Configuring (e.g., dimensioning) mixing device 158 to meet one or more of the thresholds may be based on a desired velocity of the fluid in one or more portions of mixing device 158.

In some examples, mixing device 158 is configured such that nozzle section 172 defines a p factor of about 0.25. For example, mixing device 158 may be configured such that the width W1 is about four times the width W2. This may enhance a degree of pressure reduction within mixing device 158 and improve an efficacy of the suction effect used to draw in material via suction ports 174, 176. In some examples, nozzle section 172 defines an angle subtended between nozzle section inner surface 192 and longitudinal axis L (e.g. a converging angle) of greater than or equal to about 45 degrees, in some examples greater than or equal to about 75 degrees. This converging angle may improve the fluid dynamics within nozzle section 172, enhancing acceleration of the fluid before it reaches nozzle outlet 190.

In examples, mixing device 158 includes an even number of suction ports to, for example, maintain symmetrical conditions within outlet section 168. In examples, the suction ports are substantially uniformly distributed around a circumference defined by outlet section inner surface 184 or outlet section outer surface 194. For example, each boundary (e.g., B1 and/or B2) may define a centroid of the boundary (e.g., a center point if the boundary defines a circle). The suction ports may be configured such that an angular displacement between a line intersecting a centroid of a suction port and longitudinal axis L and a line intersecting a centroid of an adjacent suction port and longitudinal axis L is consistent (e.g., substantially equivalent) for each centroid defined by each suction port. For example, the angular displacement in degrees may be substantially equal to 360 divided by the number of suction ports. For example, a mixing device defining two suction ports may define an angular displacement of about 180 degrees, a mixing device defining four suction ports may define an angular displacement of about 90 degrees, and so on.

In some examples, length L1 may be from about 15 mm to about 35 mm. in some examples from about 20 mm to about 30 mm, in some examples from about 23 mm to about 27 mm, and in some examples about 25 mm. In examples, L1 is greater than or equal to 20 mm. In some examples, a length LN defined by nozzle section 172 and nozzle inlet 188 and nozzle outlet 190 is greater than or equal to about 1 mm. Length LN may be less than or equal to about 4 mm. In examples, length LN may be from about 1 mm to about 4 mm, in some examples from about 2 mm to about 3 mm, and in some examples about 2 mm. In some examples, outlet section 168 defines suction port 174, 176 to have a cross-sectional dimension WS (e.g., a diameter) of greater than or equal to about 4 mm. Cross-sectional dimension WS may be less than or equal to about 6 mm. In examples, cross-sectional dimension WS may be from about 3 mm to about 7 mm, in some examples from about 4 mm to about 6 mm, and in some examples about 5 mm.

Width W1 may be greater than or equal to about 3.5 mm. In examples, width W1 may be less than or equal to about 7.7 mm In some examples, width W1 is from about from about 3 mm to about 7.7 mm, in some examples from about 3.5 mm to about 5.5 mm, in some examples about 5.5 mm, and in some examples about 4 mm. Width W2 may be greater than or equal to about 4 mm. In examples, width W2 is less than or equal to 2 mm. In some examples, width W2 is from about from about 0.5 mm to about 2.5 mm, in some examples from about 0.9 mm to about 2 mm, in some examples about 1.45 mm, and in some examples about 1 mm. Width W3 may be greater than or equal to about 4 mm. In examples, width W3 is less than or equal to about 7 mm. In some examples, width W3 is from about from about 3.5 mm to about 7 mm, in some examples from about 0.9 mm to about 2 mm, in some examples about 1.45 mm, and in some examples about 1 mm. As used here, when a first value is “about” a second value, this may mean the first value is within a range of minus 10% to plus 10% of the second value.

The relative dimensions of mixing device 158 may enhance a mixing of the fluid and the material and/or a suction acting through suction ports 174, 176. In examples, a ratio of width W2 to width W1 is between about 0.15 and about 0.35. In some examples, the ratio of width W2 to width W1 is about 0.25. In some examples, in addition to or instead of the ratio of width W2 to width W1, a ratio of cross-sectional dimension WS to length L1 is between about 0.1 and about 0.3. In some examples, the ratio of cross-sectional dimension WS to length L1 is about 0.2. In some examples, in addition to or instead of the ratio of width W2 to width W1 and/or in addition to or instead of the ratio of cross-sectional dimension WS to length L1, a ratio of the width W1 to the width W3 is between about 0.1 and about 0.4, and in some examples between about 0.1 and about 0.3. In some examples, the ratio of cross-sectional dimension WS to length L1 is about 0.25. In examples, length L1, length L2, cross-sectional diameter WS, and/or length LN are substantially parallel to longitudinal axis L. In examples, width W1, width W2, and/or width W3 are substantially perpendicular to longitudinal axis L. In examples, a ratio of the width WS to the width W3 is between about 0.5 and about 1.5, and in some examples between about 0.8 and about 1.2. A ratio of the width WS to the width W1 may be between about 0.5 and about 1.5, and in some examples between about 0.8 and about 1.2.

FIG. 6 illustrates an example mixing device 202 including a nozzle section 204. Nozzle section 204 includes a nozzle section inner surface 206 defining a nozzle passage 208 extending from a nozzle inlet 210 defined by nozzle section 206 to a nozzle outlet 212 defined by nozzle section 206. Mixing device 202 is an example of mixing device 158, nozzle section 204 is an example of nozzle section 172, nozzle section inner surface 206 is an example of nozzle section inner surface 192, nozzle passage 208 is an example of nozzle passage 186, nozzle inlet 210 is an example of nozzle inlet 188, and nozzle outlet 212 is an example of nozzle outlet 190.

In some examples, nozzle section inner surface 206 defines nozzle passage 208 such that nozzle passage 208 includes portions which converge at different rates or substantially do not converge as nozzle passage 208 extends from nozzle inlet 210 to nozzle outlet 212. For example, nozzle passage 208 may include a first portion 214 (“first nozzle passage portion 214”) and a second portion 216 (“second nozzle passage portion 216”) defined by nozzle section inner surface 206. First nozzle passage portion 214 may converge at a first rate or not converge as first nozzle portion passage 214 extends from nozzle inlet 210 toward nozzle outlet 212 (in FIG. 6, first nozzle portion passage 214 is depicted converging at a first rate). Second nozzle passage portion 216 may converge at a second rate different from the first rate or not converge as second nozzle portion passage 216 extends toward nozzle outlet 212 (in FIG. 6, second nozzle portion passage 216 is depicted as not converging). Nozzle passage 208 may comprise any suitable number of nozzle passage portions such as first nozzle passage portion 214 and second nozzle passage portion 216, wherein any nozzle passage portion may either not converge or converge at a rate different from other nozzle passage portions comprising nozzle passage 208. In examples, nozzle passage 208 comprises a plurality of nozzle passage portions. Nozzle passage 208 may be configured such that fluid entering through nozzle inlet 210 and exiting through nozzle outlet 212 flows through each nozzle passage in the plurality.

In some examples, first nozzle passage portion 216 may define a substantially constant cross-sectional dimension (e.g., a diameter). In some examples, first nozzle passage portion 216 defines a length LT of less than or equal to about 10 mm, in some examples less than or equal to about 5 mm. In some examples, Length LT may be substantially parallel to longitudinal axis L.

Container 104, 114, 122, 142, 156 can be constructed from a flexible or rigid material, as desired. If a rigid container is being used, then in some examples, a vent with sterile filter can be implemented for venting excess pressures. In certain examples, container 104, 114, 122, 142, 156 can be made from mono or multilayer film material, including polypropylene-polyethylene or polypropylene-polyethylene-polyamide for multilayer polyolefin-based films; a monolayer polyolefin film such as polypropylene or polyethylene, or vinyl-based films such as PVC or EVA. Alternatively, any other suitable material known to those of skill in the art can be used. In general, the materials should be non-reactive to the materials contained inside container 104, 114, 122, 142, 156. container 104, 114, 122, 142, 156 can be made from a flexible material formed from two or more pieces, such as a front pouch side 218 (FIG. 4) and a rear pouch side 220. In examples, front pouch side 218 defines a first side of container body 161 and rear pouch side 220 defines a second side of container body 161 opposite the first side. In examples, mixing device 118, 138, 140, 158 is configured such that suction port 174, 176 is substantially interposed between front pouch side 218 and second pouch side 220 such that, for example, a suction acting through suction port 174, 176 does not result in one of front pouch side 218 or second pouch side 220 from being drawn into and occluding suction port 174, 176. In some examples, front pouch side 218 and second pouch side 220 are joined by an adhesive, stitching, welding, soldering, or some other joining method. Front pouch side 218 and/or second pouch side 220 be semi-flexible, semi-rigid, or rigid. Front pouch side 218, second pouch side 220, and/or container 104, 114, 122, 142, 156 can be fabricated using any suitable process and from any suitable material depending on any desired manufacturing, usage, and size parameters.

In some examples, mixing device 118, 138, 140, 158 is made of a single injection-molded piece of material. Each of the noted features of mixing device 118, 138, 140, 158, 202 may be made integrally from the single injection molded piece.

In addition to, or as an alternative to mixing device 118, 138, 140, 158, 202, system 100 can include other mixing elements that manipulate flow or cause turbulence to mix a fluid (e.g., water) with the solid or highly concentrated liquid material in container 104, 114, 122, 142, 156. In certain examples, the mixing element can include one or more of a static mixer, a propeller, a magnetic stirrer, a vibration plate, or any other element or nozzle that can create turbulence to facilitate mixing.

Depending on flow rates, solute composition, and other parameters, the geometrical configuration (e.g., dimensions) of mixing device 118, 138, 140, 158, 202 may be designed to meet the specific application requirements of its intended application. For example, the provided dimensions can be suitable for a flow rate of about 400 milliliters per minute (mL/min). However, the specific dimensions can vary according to the flow rate and the physical properties of materials such as solid concentrates, liquid concentrates, and/or other materials, according to the maximum allowable operating pressure.

Control circuitry 120 may include fixed function circuitry and/or programmable operating circuitry. In examples, control circuitry 120 includes circuitry configured to perform one or more functions of operating circuitry, such as sensing circuitry, processing circuitry, switching circuitry, communication circuitry, and/or other circuitries. Control circuitry 120, as well as other processors, operating circuitry, controllers, control circuitry, processing circuitry, and the like, described herein, may include any combination of integrated circuitry, discrete logic circuitry, analog circuitry, such as one or more microprocessors, digital signal processors (DSPs), application specific integrated circuits (ASICs), or field-programmable gate arrays (FPGAs). In some examples, control circuitry 120 includes multiple components, such as any combination of one or more microprocessors, one or more DSPs, one or more ASICs, or one or more FPGAs, as well as other discrete or integrated logic circuitry, and/or analog circuitry.

Functions attributed to control circuitry 120 may be embodied as software, firmware, hardware or any combination thereof. Control circuitry 120 may include, for instance, a variety of capacitors, transformers, switches, and the like configured to perform the functions of control circuitry 120. In examples, control circuitry 120 may be configured to communicate with another device, such as pump 105, 108, valve 113, 124, 126, sensor 111, 128, 130, purification module 103, sterilization module 106, heater 109, 154, and/or other system and/or components of system 100. Control circuitry 120 may include any suitable hardware, firmware, software or any combination thereof for communicating with another device. In addition, control circuitry 120 may communicate with a networked computing device and a computer network.

System 100 (e.g., control circuitry 120) can also include memory configured to store program instructions, such as software, which may include one or more program modules, which are executable by control circuitry 120. The program instructions may be embodied in software and/or firmware. The memory can include any volatile, non-volatile, magnetic, optical, or electrical media, such as a random access memory (RAM), read-only memory (ROM), non-volatile RAM (NVRAM), electrically-erasable programmable ROM (EEPROM), ferroelectric RAM (FRAM), flash memory, or any other digital media. In some examples, the memory includes computer-readable instructions that, when executed by control circuitry 120 cause control circuitry 120 to perform various functions described herein and/or other functions of control circuitry 120.

Communication links 121, 123, 125, 127, and/or other communication links of system 100 may be hard-line and/or wireless communications links. In some examples, communication links 121, 123, 125, 127, and/or other communication links may comprise some portion of control circuitry 120. In some examples, communication links 121, 123, 125, 127, and/or other communication links comprise a wired connection, a wireless Internet connection, a direct wireless connection such as wireless LAN, Bluetooth™, Wi-Fi™, and/or an infrared connection. Communication links 121, 123, 125, 127, and/or other communication links may utilize any wireless or remote communication protocol.

As used here, when a first portion of a system (e.g., system 100) is substantially parallel to a second portion of or an axis defined by the system, this may mean the first portion is parallel or nearly parallel to the second portion or the axis to the extent permitted by manufacturing tolerances. In some examples, when the first portion is substantially parallel to the second portion or the axis, this may mean a first vector defined by the first component of the system defines an angle of less than 10 degrees, in some examples less than 5 degrees, and in some examples less than 1 degree, with a second vector defined by the second component or the axis. When a first portion is substantially perpendicular to the second portion of or the axis defined by the system, this may mean the first portion is perpendicular or nearly perpendicular to the second portion or the axis to the extent permitted by manufacturing tolerances. In some examples, when the first portion is substantially perpendicular to the second portion or the axis, this may mean the first vector defined by the first component defines an angle of less than 80 degrees, in some examples less than 85 degrees, and in some examples less than 89 degrees, with the second vector defined by the second component or the axis.

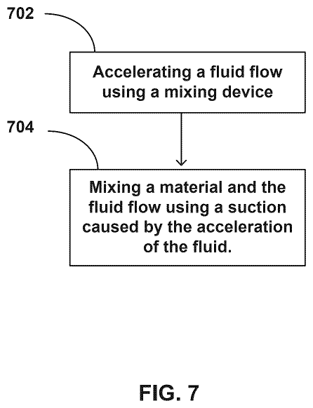

FIG. 7 is a flow diagram illustrating an example technique for mixing a fluid and a material using a mixing device. While the technique is described with reference to system 100, 200 and mixing device 118-202 described herein, the technique may be used with other components and/or systems in other examples.

The technique includes accelerating, using a nozzle section 172, 204 of a mixing device 118-202, a fluid flow received by an inlet section 164 of mixing device 118-202 (702).

The fluid flow may be accelerated by flowing the fluid flow through a nozzle section 172, 204 of mixing device 118-202. In examples, the fluid flow is accelerated by flowing the fluid flow through a nozzle passage 186, 208 of nozzle section 172, 204 which extends from a nozzle inlet 188, 210 to a nozzle outlet 190, 212. In examples, the fluid flow is accelerated by flowing the fluid flow into nozzle inlet 188, 210 defining a width W1 and discharging the fluid flow from nozzle outlet 190, 212 defining a width W2 which is less than about 30% of the width W1.

The technique may include discharging the fluid flow through nozzle outlet 190, 212 into an outlet section 168 (e.g., into an outlet passage 182) of mixing device 118-202. In examples, discharging the fluid flow into outlet section 168 includes discharging the fluid flow from nozzle outlet 190, 212 to a portion of outlet passage 182 defined by a wall surface 198 of outlet section 168. Discharging the fluid flow through nozzle outlet 190, 212 may cause a reduction of the pressure of the fluid flow within outlet passage 182. The suction may cause mixing device 118-202 through one or more suctions ports 174, 176 defined by outlet section 168. In examples, the suction causes suction ports 174, 176 to draw the material into outlet passage 182 from a volume separated from outlet passage 182 by a boundary wall 185 of outlet section 168.

The technique includes mixing the material and the fluid flow within outlet passage 182 (704). In examples, mixing device 118-202 discharges the material and the fluid flow through a device outlet 170 of outlet section 168. Mixing device 118-202 may cause at least some degree of mixing of the material and the fluid flow as the material and the fluid flow moves through outlet passage 182 toward device outlet 170. In examples, mixing device 118-202 discharges the material and the fluid flow into a container volume 107, 115, 123, 143, 157 defined by a container 104, 114, 122, 142, 156. In examples, container volume 107, 115, 123, 143, 157 holds the material. Suction ports 174, 176 may draw the material into outlet passage 182 from container volume 107, 115, 123, 143, 157. In examples, the material is a solid concentrate and/or a liquid contrate which comprises a medical solution such as a peritoneal dialysis fluid. In examples, the fluid flow comprises water (e.g., purified water).

In examples, the fluid flow comprises at least one of a first fluid, a first solution, a second fluid, or a second solution. The technique may include pumping, using one or more pumps, the first fluid into container volume 107 defined by container 104 to cause mixing of the first fluid and a first concentrate held within container volume 107. Pumping the first fluid may produce the first solution in container volume 107. The technique may include pumping, using the one or more pumps, the second fluid into container volume 123 defined by container 122 to cause mixing of the second fluid and a second concentrate held within container volume 123. Pumping the second fluid may produce the second solution in container volume 123. In examples, the technique includes pumping, using the one or more pumps 105, 108, the first solution from container volume 107 to container volume 115 defined by container 114. The technique includes pumping, using pumps 105, 108, the second solution from container volume 123 to container volume 115. In examples, the technique includes mixing, using mixing device 118-202, the first solution and the second solution. In examples, mixing device 118-202 draws one of the first solution or the second solution through suction ports 174, 176 (e.g., from container volume 115) as mixing device 118-202 receive the other of the first solution or the second solution via device inlet 166.

In examples, control circuitry 120 causes pumps 105, 108 to pump the first fluid into container volume 107. Control circuitry 120 may cause pumps 105, 108 to pump the second fluid into container volume 123. Control circuitry 120 may cause pumps 105, 108 to pump the first solution and/or the second solution into container volume 115. In examples, control circuitry 120 causes pumps 105, 108 to pump at least one of the first fluid, the first solution, the second fluid, or the second solution based on a signal from a sensor 111,128, 130 configured to sense a concentration of the first fluid, the first solution, the second fluid, or the second solution. In examples, control circuitry 120 may cause pumps 105, 108 to pump an additional amount of fluid into at least one of container volume 107, container volume 115, or container volume 123 based on the signal. In some examples, control circuitry 120 may cause pumps 105, 108 to pump a first amount of the first solution to container volume 115 and pump a second amount of the second solution to container volume 115, wherein the first amount and the second amount comprise the medical solution (e.g., a peritoneal dialysis fluid).

Various examples have been described. These and other examples are within the scope of the following claims.

What is claimed is:

1. A mixing device comprising:
an inlet section configured to receive a fluid flow;
a nozzle section defining:
a nozzle inlet configured to receive the fluid flow from the inlet section,
a nozzle outlet configured to discharge the fluid flow, and
a nozzle passage fluidically coupling the nozzle inlet and the nozzle outlet,
wherein a width of the nozzle passage at the nozzle inlet and transverse to a direction of the fluid flow is greater than a width of the nozzle passage at the nozzle outlet and transverse to the direction of the fluid flow; and
an outlet section configured to receive the fluid flow from the nozzle outlet and defining a device outlet configured to discharge the fluid flow,
wherein the outlet section defines a wall surface and an outlet passage extending from the wall surface to the device outlet,
wherein the nozzle outlet opens to the wall surface,
wherein a width of the wall surface transverse to the direction of the fluid flow is greater than the width of the nozzle passage at the nozzle outlet, and
wherein the outlet section defines a suction port which opens into the outlet passage in proximity to the wall surface such that a suction produced by the fluid flow passing through the nozzle section into the outlet section draws a material through the suction port and into the fluid flow.

2. The mixing device of claim 1, wherein a length of the outlet section defined in the direction of fluid flow through the device outlet is no greater than about four times a width of the outlet section defined transverse to the direction of the fluid flow.

3. The mixing device of claim 1, wherein the width of the nozzle passage at the nozzle outlet is less than or equal to about 30% of the width of the nozzle passage at the nozzle inlet.

4. The mixing device of claim 1, wherein the inlet section defines a device inlet configured to receive the fluid flow and an inlet passage extending from the device inlet to the nozzle inlet, and wherein a width defined by the inlet section and transverse to the direction of the fluid flow is less than a width defined by the outlet section and transverse to the direction of the fluid flow.

5. The mixing device of claim 4, wherein the width defined by the inlet section is substantially constant from the device inlet to the nozzle inlet.

6. The mixing device of claim 4, wherein the width defined by the outlet section is substantially constant from the wall surface to the device outlet.

7. The mixing device of claim 1, wherein the outlet section defines a first length from the wall surface to the device outlet and defines a second length from the wall surface to a boundary of the suction port, wherein the second length is less than or equal to about 10% of the first length.

8. An assembly comprising:
the mixing device of claim 1, wherein the inlet section defines a device inlet configured to receive the fluid flow; and
a container secured to the mixing device, wherein the container defines a volume configured to hold the fluid flow discharged by the outlet, wherein the device inlet is configured to receive the fluid flow from outside the volume, and wherein the device outlet and the suction port open into the volume.

9. The assembly of claim 8, wherein the container is configured to dispense at least one of a powdered solute or a concentrated solution through the suction port when the fluid flow produces the suction.

10. The assembly of claim 9, wherein the powdered solute or the concentrated solution is configured to mix with water to form a peritoneal dialysis fluid.

11. The mixing device of claim 1, wherein the width defined by the outlet section is less than or equal to about 2 millimeters.

12. The mixing device of claim 1, wherein the width defined by of the inlet section is less than or equal to about 5.5 millimeters.

13. The mixing device of claim 1, wherein the device inlet is configured to be fluidically coupled to a source of purified water.

14. The mixing device of claim 1, wherein the inlet section, the nozzle section, and the outlet section are formed from a single injection-molded polymer component.

15. The mixing device of claim 1, wherein the nozzle section tapers in a direction from the nozzle inlet toward the nozzle outlet such that the nozzle outlet is narrower than the nozzle inlet.

16. A system for generating a peritoneal dialysis fluid, the system comprising:
a first container defining a first volume configured to hold a first fluid;
a second container defining a second volume configured to hold a second fluid, wherein at least one of the first volume or the second volume holds a concentrate, the concentrate including ions, dextrose, or mixtures thereof, and wherein the concentrate is one of a liquid or a powder;
a third container defining a third volume,
wherein the system defines a first flow path for the first fluid from the first volume to the third volume and defines a second flow path for the second fluid from the second volume to the third volume,
wherein at least one of the first container, the second container, or the third container includes a mixing device, the mixing device defining:
a device inlet configured to receive a fluid flow,
a device outlet configured to discharge the fluid flow, and
a suction port between the device inlet and the device outlet, wherein the suction port is configured such that a suction produced when the fluid flow passes from the device inlet to the device outlet draws a material from the one of the first container, the second container, or the third container through the suction port to cause the material to mix with fluid flow; and
at least one sensor configured to sense a concentration of the concentrate in at least one of the first fluid, the second fluid, or a fluid in the third volume.

17. The system of claim 16, further comprising:
at least one pump configured to pump at least one of the first fluid or the second fluid, and
control circuitry configured to control the pump to pump the first fluid or the second fluid based on a signal received from the at least one sensor.

18. The system of claim 16, wherein the first volume holds a first concentrate and the second volume holds a second concentrate, and wherein the control circuitry is configured to at least one of:
control the at least one pump to pump the first fluid into the first volume to produce a first solution comprising the first concentrate in the first volume;
control the at least one pump to pump the second fluid into the second volume to produce a second solution comprising the second concentrate in the second volume; or
control the at least one pump to pump the first solution from the first container to the third container and pump the second solution from the second container to the third container.

19. A method, comprising:
accelerating, using a nozzle inlet of a nozzle section of a mixing device, a fluid flow received by an inlet section of the mixing device;
producing, using the fluid flow, a suction in an outlet section of the mixing device by receiving the fluid flow from a nozzle outlet of the nozzle section, wherein the nozzle outlet opens to a wall surface defined by the outlet section, and wherein the outlet section defines an outlet passage extending from the wall surface to the device outlet;
drawing, through a suction port defined by the outlet section in proximity to the wall surface and opening into the outlet passage, a material into the fluid flow using a suction produced by the acceleration of the fluid flow; and
discharging, through a device outlet defined by the outlet section, the fluid flow and the material.

20. The method of claim 19, further comprising accelerating the fluid flow by at least flowing the fluid flow through a nozzle passage of the nozzle section, wherein the nozzle passage extends from a nozzle inlet to a nozzle outlet, and a width of the nozzle passage at the nozzle outlet and traverse to a direction of the fluid flow is less than or equal to about 30% of a width of the nozzle passage at the nozzle inlet and traverse to the direction of the fluid flow.
